(19) United States
(12) Patent Application Publication
(10) Pub. No.: US 2024/0402692 A1
(43) Pub. Date: Dec. 5, 2024

(54) BUILDING MANAGEMENT SYSTEM WITH BUILDING EQUIPMENT SERVICING

(71) Applicant: Tyco Fire & Security GmbH, Neuhausen am Rheinfall (CH)

(72) Inventors: Kristen Sheppard-Guzelaydin, West Chester, PA (US); Julie Joanne Brown, Yardley, PA (US); Vineet Binodshanker Sinha, Brookfield, WI (US); Arunkumar Vedhathiri, Albany, NY (US); Trent M. Swanson, Wellington, FL (US); Miguel Galvez, Westford, MA (US); Kaleb Luedtke, West Bend, WI (US); Gregory A. Makowski, Los Altos, CA (US); Sastry KM Malladi, Fremont, CA (US); Michael J. Wenzel, Grafton, WI (US); Thomas M. Seneczko, Milwaukee, WI (US)

(21) Appl. No.: 18/679,191

(22) Filed: May 30, 2024

Related U.S. Application Data
(60) Provisional application No. 63/470,155, filed on May 31, 2023.

(51) Int. Cl. G05B 19/418

(52) U.S. Cl. CPC G05B 19/41875; G05B 19/4184; G05B 2219/32204

(57) ABSTRACT

Systems and methods are disclosed relating to user interface generation using machine learning models. A system can include one or more processors configured to receive, from a device associated with a user identifier, a prompt for generating data regarding a building management system. The one or more processors can generate, using at least one machine learning model, a completion to the prompt based at least on the prompt and the user identifier, the completion indicating one or more actions corresponding to a performance target for the building management system. The one or more processors can present the completion using at least one of a display device or an audio output device.

### CROSS-REFERENCE TO RELATED APPLICATIONS

This application claims the benefit of and priority to U.S. Provisional Application No. 63/470,155, filed May 31, 2023, the disclosure of which is incorporated herein by reference in its entirety.

### BACKGROUND

This application relates generally to a building system of a building. This application relates more particularly to systems for managing and processing data of the building system. Various interactions between building systems, components of building systems, users, technicians, and/or devices managed by users or technicians can rely on timely generation and presentation of data relating to the interactions, including for performing service operations. However, it can be difficult to generate the data elements to precisely identify proper response actions or sequences of response actions, as well as options for modified response actions, depending on various factors.

### SUMMARY

Some implementations relate to a method, including receiving, by one or more processors, from a device associated with a user identifier, a prompt for generating data regarding a building management system. The method further including generating, by the one or more processors, using at least one generative artificial intelligence (AI) model, a completion to the prompt based at least on the prompt and the user identifier, the completion indicating one or more actions corresponding to a performance target for the building management system. The method further including presenting, by the one or more processors, the completion using at least one of a display device or an audio output device.

In some implementations, the method further including identifying, by the one or more processors, the performance target by processing the prompt using the at least one generative AI model, the performance target includes at least one of an operating parameter of one or more items of equipment associated with the building management system or a key performance index (KPI) of the one or more items of equipment. In some implementations, the at least one generative AI model is configured using training data including data of at least one other item of equipment or building previously modified to achieve a related KPI, the related KPI is a measurable metric associated with at least one of (i) an operating parameter of the at least one other item of equipment or building or (ii) a value of the operating parameter, and the generative AI model includes at least one neural network including at least one transformer. In some implementations, the method further including generating, by the one or more processors, skeleton code to execute the one or more actions, the skeleton code includes one or more code sections corresponding to the one or more actions, and the one or more code sections includes the skeleton code corresponding to at least one of adjusting an energy usage, modifying a temperature control setting, modifying a lighting condition, reconfiguring a space utilization, updating an air quality indicator, updating a security protocol, updating a maintenance schedule, or optimizing a waste management, receiving, by the one or more processors, input to update the skeleton code, the input includes at least one modification or at least one instruction to update at least one operating parameter of the building management system, and updating, by the one or more processors, the skeleton code based on the input, updating the skeleton code includes incorporating the at least one modification or implementing the at least one instruction into the skeleton code.

In some implementations, the method further including receiving, by the one or more processors, real-time operational data from the building management system, the real-time operational data includes at least one of energy usage data, temperature reading, lighting condition, space utilization metric, air quality indicator, security status, maintenance schedule, or waste management metric and generating, by the one or more processors, updates to the completion based on the real-time operational data, the updates to the completion include at least one modification to the one or more actions to align with the performance target. In some implementations, the method further including activating, by the one or more processors, a co-pilot model of the generative AI to facilitate executing the one or more actions related to the performance target, activating the co-pilot model includes initiating a session with the co-pilot model through a user interface, the user interface receives the real-time operational data and a plurality of prompts, modeling using the co-pilot model, the real-time operational data and the plurality of prompts to generate one or more actionable recommendations corresponding to the performance target, presenting the one or more actionable recommendations via the user interface, and updating the one or more actionable recommendations based on new real-time operational data or a new prompt.

In some implementations, the user interface is presented on the display device including the completion, and the user interface is personalized to the user identifier based on a user preference, a user interest, or a previous interaction associated with using the at least one generative AI model. In some implementations, the one or more actions include customized natural language based on account information associated with the user identifier, the customized natural language is customized, using the account information, according to at least one of a choice of vocabulary, a level of technicality, a depth of detail, or a preferred communication style, and the generative AI model is configured using training data including the account information. In some implementations, the completion includes a synthetization of one or more reports, the presentation of the completion includes a design customized to the user identifier or the building management system, and the synthetization includes aggregating data and content of the one or more reports from a plurality of data sources and generating insights corresponding with one of a plurality of performance targets or operational goals of the building management system. In some implementations, the at least one generative AI model implements reinforcement learning, the reinforcement learning includes updating the at least one generative AI model based on receiving feedback on an effectiveness of generated completions indicating the one or more actions.

Some implementations relate to system, including processing circuits including memory and at least one processor. The at least one processor is configured to receive from a device associated with a user identifier, a prompt for generating data regarding a building management system. The at least one processor is configured to generate using at least one generative artificial intelligence (AI) model, a completion to the prompt based at least on the prompt and the user identifier, the completion indicating one or more actions corresponding to a performance target for the building management system. The at least one processor is configured to present the completion using at least one of a display device or an audio output device.

In some implementations, the at least one processor is further configured to identify the performance target by processing the prompt using the at least one generative AI model, the performance target includes at least one of an operating parameter of one or more items of equipment associated with the building management system or a key performance index (KPI) of the one or more items of equipment. In some implementations, the at least one generative AI model is configured using training data including data of at least one other item of equipment or building previously modified to achieve a related KPI, the related KPI is a measurable metric associated with at least one of (i) an operating parameter of the at least one other item of equipment or building or (ii) a value of the operating parameter, and the generative AI model includes at least one neural network including at least one transformer. In some implementations, the at least one processor is further configured to generate skeleton code to execute the one or more actions, the skeleton code includes one or more code sections corresponding to the one or more actions, and the one or more code sections includes the skeleton code corresponding to at least one of adjusting an energy usage, modifying a temperature control setting, modifying a lighting condition, reconfiguring a space utilization, updating an air quality indicator, updating a security protocol, updating a maintenance schedule, or optimizing a waste management, receive input to update the skeleton code, the input includes at least one modification or at least one instruction to update at least one operating parameter of the building management system, and update the skeleton code based on the input, updating the skeleton code includes incorporating the at least one modification or implementing the at least one instruction into the skeleton code.

In some implementations, the at least one processor is further configured to receive real-time operational data from the building management system, the real-time operational data includes at least one of energy usage data, temperature reading, lighting condition, space utilization metric, air quality indicator, security status, maintenance schedule, or waste management metric, and generate updates to the completion based on the real-time operational data, the updates to the completion include at least one modification to the one or more actions to align with the performance target. In some implementations, the at least one processor is further configured to activate a co-pilot model of the generative AI to facilitate executing the one or more actions related to the performance target, activating the co-pilot model includes initiating a session with the co-pilot model through a user interface, the user interface receives the real-time operational data and a plurality of prompts, modeling using the co-pilot model, the real-time operational data and the plurality of prompts to generate one or more actionable recommendations corresponding to the performance target, presenting the one or more actionable recommendations via the user interface, and updating the one or more actionable recommendations based on new real-time operational data or a new prompt.

In some implementations, the user interface is presented on the display device including the completion, and the user interface is personalized to the user identifier based on a user preference, a user interest, or a previous interaction associated with using the at least one generative AI model. In some implementations, the one or more actions include customized natural language based on account information associated with the user identifier, the customized natural language is customized, using the account information, according to at least one of a choice of vocabulary, a level of technicality, a depth of detail, or a preferred communication style, and the generative AI model is configured using training data including the account information. In some implementations, the at least one generative AI model implements reinforcement learning, the reinforcement learning includes updating the at least one generative AI model based on receiving feedback on an effectiveness of generated completions indicating the one or more actions.

Some implementations relate to a non-transitory computer readable medium (CRM) including one or more instructions stored thereon that, when executed by one or more processing circuits, cause the one or more processing circuits to perform operations including receiving from a device associated with a user identifier, a prompt for generating data regarding a building management system. The non-transitory CRM including the one or more instructions stored thereon that, when executed by the one or more processing circuits, cause the one or more processing circuits to perform additional operations including generating using at least one generative artificial intelligence (AI) model, a completion to the prompt based at least on the prompt and the user identifier, the completion indicating one or more actions corresponding to a performance target for the building management system. The non-transitory CRM including the one or more instructions stored thereon that, when executed by the one or more processing circuits, cause the one or more processing circuits to perform additional operations including presenting the completion using at least one of a display device or an audio output device.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of an example of a machine learning model-based system for equipment servicing applications.

FIG. 2 is a block diagram of an example of a language model-based system for equipment servicing applications.

FIG. 3 is a block diagram of an example of the system of FIG. 2 including user application session components.

FIG. 4 is a block diagram of an example of the system of FIG. 2 including feedback training components.

FIG. 5 is a block diagram of an example of the system of FIG. 2 including data filters.

FIG. 6 is a block diagram of an example of the system of FIG. 2 including data validation components.

FIG. 7 is a block diagram of an example of the system of FIG. 2 including expert review and intervention components.

FIG. 8 is a flow diagram of a method of managing equipment servicing responsive to fault detection using machine learning models.

FIG. 9 is a flow diagram of a method of providing interfaces blending objectives using machine learning models.

### DETAILED DESCRIPTION

Referring generally to the FIGURES, systems and methods in accordance with the present disclosure can implement various systems to precisely generate data relating to operations to be performed for managing building systems and components and/or items of equipment, including heating, ventilation, cooling, and/or refrigeration (HVAC-R) systems and components. For example, various systems described herein can implement generating data for numerous applications, including virtual assistance for technicians handling service requests, generating service-related technical reports, facilitating diagnostics and troubleshooting procedures, and providing recommendations for services or products to be utilized during service operations. These applications can assist in both asynchronous and real-time service operations by generating text data, using data from diverse data sources that may not have predefined database associations, yet may be pertinent at certain steps or moments during service operations.

In some systems, service operations can be supported by text information, such as predefined text documents such as service, diagnostic, and/or troubleshooting guides. Various such text information may not be useful for specific service requests and/or technicians performing the service. For example, the text information may correspond to different items of equipment or versions of items of equipment to be serviced. The text information, being predefined, may not account for specific technical issues that may be present in the items of equipment to be serviced.

AI and/or machine learning (ML) systems, including but not limited to LLMs, can be used to receive prompts from a device associated with a unique user or building identifier. These prompts, which could originate from a variety of user interfaces can request data concerning the operation, management, or status of a building management system (BMS). The generative AI model, executed by the processing circuits, uses these prompts along with the identifier to generate personalized and actionable responses, indicating one or more actions to achieve a specific performance target for the BMS.

In addition, the AI and/or ML systems can identify performance targets and key performance indicators (KPIs) that define the goals the BMS aims to achieve (e.g., qualitative or quantitative goals assigned to a BMS according to user input, or determined by the BMS according to KPIs), using the prompts and the unique identifiers. In various implementations, the identified KPIs can then be tracked and used to evaluate the system's performance. Thus, a generative AI model can propose relevant actions for specific issues, such as suggesting HVAC settings adjustments or recommending preventative maintenance for certain equipment. In some implementations, to execute these actions, the processing circuits generate a skeletal code, a simplified version of a codebase, which can serve as a framework. The final output indicating the actions to reach the BMS performance target can be presented using a display device or an audio output device, personalized based on the user's role, permissions, and preferences.

As outlined in the FIGURES, the systems and methods utilize a generative AI model to generate data for managing building systems and equipment, such as HVAC-R systems. These systems facilitate various operations, from virtual assistance for technicians to diagnostics and troubleshooting, by interpreting prompts from user or building identifiers and subsequently generating personalized responses, thereby addressing the longstanding problem of inflexible, predefined service guides. An improvement to this is the AI model's ability to identify unique performance targets and key performance indicators (KPIs) based on the prompts and identifiers, which can then tracked to assess the system's performance. Accordingly, this technical solution improves the management of building systems by incorporating personalized, real-time assistance and recommendations, which improves service and building operations and the performance evaluation of the entire system.

Furthermore, AI and/or machine learning (ML) systems, including but not limited to LLMs, can be used to generate text data and data of other modalities in a more responsive manner to real-time conditions, including generating strings of text data that may not be provided in the same manner in existing documents, yet may still meet criteria for useful text information, such as relevance, style, and coherence. For example, LLMs can predict text data based at least on inputted prompts and by being configured (e.g., trained, modified, updated, fine-tuned) according to training data representative of the text data to predict or otherwise generate.

However, various considerations may limit the ability of such systems to precisely generate appropriate data for specific conditions. For example, due to the predictive nature of the generated data, some LLMs may generate text data that is incorrect, imprecise, or not relevant to the specific conditions. Using the LLMs may require a user to manually vary the content and/or syntax of inputs provided to the LLMs (e.g., vary inputted prompts) until the output of the LLMs meets various objective or subjective criteria of the user. The LLMs can have token limits for sizes of inputted text during training and/or runtime/inference operations (and relaxing or increasing such limits may require increased computational processing, API calls to LLM services, and/or memory usage), limiting the ability of the LLMs to be effectively configured or operated using large amounts of raw data or otherwise unstructured data.

Systems and methods in accordance with the present disclosure can use machine learning models, including LLMs and other generative AI systems, to capture data, including but not limited to unstructured knowledge from various data sources, and process the data to accurately generate outputs, such as completions responsive to prompts, including in structured data formats for various applications and use cases. The system can implement various automated and/or expert-based thresholds and data quality management processes to improve the accuracy and quality of generated outputs and update training of the machine learning models accordingly. The system can facilitate real-time messaging and/or conversational interfaces for users to provide field data regarding equipment to the system (including presenting targeted queries to users that are expected to elicit relevant responses for efficiently receiving useful response information from users) and guide users, such as service technicians, through relevant service, diagnostic, troubleshooting, and/or repair processes.

This can include, for example, receiving data from technician service reports in various formats, including various modalities and/or multi-modal formats (e.g., text, speech, audio, image, and/or video). The system can facilitate automated, flexible customer report generation, such as by processing information received from service technicians and other users into a standardized format, which can reduce the constraints on how the user submits data while improving resulting reports. The system can couple unstructured service data to other input/output data sources and analytics, such as to relate unstructured data with outputs of timeseries data from equipment (e.g., sensor data; report logs) and/or outputs from models or algorithms of equipment operation, which can facilitate more accurate analytics, prediction services, diagnostics, and/or fault detection. The system can perform classification or other pattern recognition or trend detection operations to facilitate more timely assignment of technicians, scheduling of technicians based on expected times for jobs, and provisioning of trucks, tools, and/or parts. The system can perform root cause prediction by being trained using data that includes indications of root causes of faults or errors, where the indications are labels for or otherwise associated with (unstructured or structure) data such as service requests, service reports, service calls, etc. The system can receive, from a service technician in the field evaluating the issue with the equipment, feedback regarding the accuracy of the root cause predictions, as well as feedback regarding how the service technician evaluated information about the equipment (e.g., what data did they evaluate; what did they inspect; did the root cause prediction or instructions for finding the root cause accurately match the type of equipment, etc.), which can be used to update the root cause prediction model.

For example, the system can provide a platform for fault detection and servicing processes in which a machine learning model is configured based on connecting or relating unstructured data and/or semantic data, such as human feedback and written/spoken reports, with time-series product data regarding items of equipment, so that the machine learning model can more accurately detect causes of alarms or other events that may trigger service responses. For instance, responsive to an alarm for a chiller, the system can more accurately detect a cause of the alarm, and generate a prescription (e.g., for a service technician) for responding to the alarm; the system can request feedback from the service technician regarding the prescription, such as whether the prescription correctly identified the cause of the alarm and/or actions to perform to respond to the cause, as well as the information that the service technician used to evaluate the correctness or accuracy of the prescription; the system can use this feedback to modify the machine learning models, which can increase the accuracy of the machine learning models.

In some instances, significant computational resources (or human user resources) can be required to process data relating to equipment operation, such as time-series product data and/or sensor data, to detect or predict faults and/or causes of faults. In addition, it can be resource-intensive to label such data with identifiers of faults or causes of faults, which can make it difficult to generate machine learning training data from such data. Systems and methods in accordance with the present disclosure can leverage the efficiency of language models (e.g., GPT-based models or other pre-trained LLMs) in extracting semantic information (e.g., semantic information identifying faults, causes of faults, and other accurate expert knowledge regarding equipment servicing) from the unstructured data in order to use both the unstructured data and the data relating to equipment operation to generate more accurate outputs regarding equipment servicing. As such, by implementing language models using various operations and processes described herein, building management and equipment servicing systems can take advantage of the causal/semantic associations between the unstructured data and the data relating to equipment operation, and the language models can allow these systems to more efficiently extract these relationships in order to more accurately predict targeted, useful information for servicing applications at inference-time/runtime. While various implementations are described as being implemented using generative AI models such as transformers and/or GANs, in some embodiments, various features described herein can be implemented using non-generative AI models or even without using AI/machine learning, and all such modifications fall within the scope of the present disclosure.

The system can provide a generative AI-based service wizard interface. For example, the interface can include user interface and/or user experience features configured to provide a question/answer-based input/output format, such as a conversational interface, that directs users through providing targeted information for accurately generating predictions of root cause, presenting solutions, or presenting instructions for repairing or inspecting the equipment to identify information that the system can use to detect root causes or other issues. The system can use the interface to present information regarding parts and/or tools to service the equipment, as well as instructions for how to use the parts and/or tools to service the equipment.

In various implementations, the systems can include a plurality of machine learning models that may be configured using integrated or disparate data sources. This can facilitate more integrated user experiences or more specialized (and/or lower computational usage for) data processing and output generation. Outputs from one or more first systems, such as one or more first algorithms or machine learning models, can be provided at least as part of inputs to one or more second systems, such as one or more second algorithms or machine learning models. For example, a first language model can be configured to process unstructured inputs (e.g., text, speech, images, etc.) into a structure output format compatible for use by a second system, such as a root cause prediction algorithm or equipment configuration model.

The system can be used to automate interventions for equipment operation, servicing, fault detection and diagnostics (FDD), and alerting operations. For example, by being configured to perform operations such as root cause prediction, the system can monitor data regarding equipment to predict events associated with faults and trigger responses such as alerts, service scheduling, and initiating FDD or modifications to configuration of the equipment. The system can present to a technician or manager of the equipment a report regarding the intervention (e.g., action taken responsive to predicting a fault or root cause condition) and requesting feedback regarding the accuracy of the intervention, which can be used to update the machine learning models to more accurately generate interventions.

### I. Machine Learning Models for Building Management and Equipment Servicing

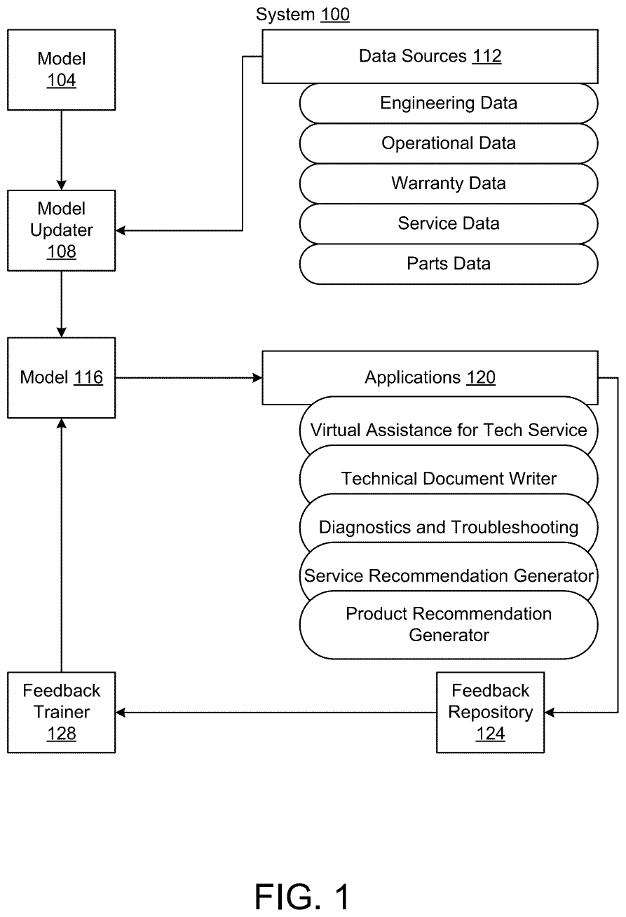

FIG. 1 depicts an example of a system 100. The system 100 can implement various operations for configuring (e.g., training, updating, modifying, transfer learning, fine-tuning, etc.) and/or operating various AI and/or ML systems, such as neural networks of LLMs or other generative AI systems. The system 100 can be used to implement various generative AI-based building equipment servicing operations.

For example, the system 100 can be implemented for operations associated with any of a variety of building management systems (BMSs) or equipment or components thereof. A BMS can include a system of devices that can control, monitor, and manage equipment in or around a building or building area. The BMS can include, for example, a HVAC system, a security system, a lighting system, a fire alerting system, any other system that is capable of managing building functions or devices, or any combination thereof. The BMS can include or be coupled with items of equipment, for example and without limitation, such as heaters, chillers, boilers, air handling units, sensors, actuators, refrigeration systems, fans, blowers, heat exchangers, energy storage devices, condensers, valves, or various combinations thereof.

The items of equipment can operate in accordance with various qualitative and quantitative parameters, variables, setpoints, and/or thresholds or other criteria, for example. In some instances, the system 100 and/or the items of equipment can include or be coupled with one or more controllers for controlling parameters of the items of equipment, such as to receive control commands for controlling operation of the items of equipment via one or more wired, wireless, and/or user interfaces of controller.

Various components of the system 100 or portions thereof can be implemented by one or more processors coupled with or more memory devices (memory). The processors can be a general purpose or specific purpose processors, an application specific integrated circuit (ASIC), one or more field programmable gate arrays (FPGAs), a group of processing components, or other suitable processing components. The processors may be configured to execute computer code and/or instructions stored in the memories or received from other computer readable media (e.g., CDROM, network storage, a remote server, etc.). The processors can be configured in various computer architectures, such as graphics processing units (GPUs), distributed computing architectures, cloud server architectures, client-server architectures, or various combinations thereof. One or more first processors can be implemented by a first device, such as an edge device, and one or more second processors can be implemented by a second device, such as a server or other device that is communicatively coupled with the first device and may have greater processor and/or memory resources.

The memories can include one or more devices (e.g., memory units, memory devices, storage devices, etc.) for storing data and/or computer code for completing and/or facilitating the various processes described in the present disclosure. The memories can include random access memory (RAM), read-only memory (ROM), hard drive storage, temporary storage, non-volatile memory, flash memory, optical memory, or any other suitable memory for storing software objects and/or computer instructions. The memories can include database components, object code components, script components, or any other type of information structure for supporting the various activities and information structures described in the present disclosure. The memories can be communicably connected to the processors and can include computer code for executing (e.g., by the processors) one or more processes described herein.

### Machine Learning Models

The system 100 can include or be coupled with one or more first models 104. The first model 104 can include one or more neural networks, including neural networks configured as generative models. For example, the first model 104 can predict or generate new data (e.g., artificial data; synthetic data; data not explicitly represented in data used for configuring the first model 104). The first model 104 can generate any of a variety of modalities of data, such as text, speech, audio, images, and/or video data. The neural network can include a plurality of nodes, which may be arranged in layers for providing outputs of one or more nodes of one layer as inputs to one or more nodes of another layer. The neural network can include one or more input layers, one or more hidden layers, and one or more output layers. Each node can include or be associated with parameters such as weights, biases, and/or thresholds, representing how the node can perform computations to process inputs to generate outputs. The parameters of the nodes can be configured by various learning or training operations, such as unsupervised learning, weakly supervised learning, semi-supervised learning, or supervised learning.

The first model 104 can include, for example and without limitation, one or more language models, LLMs, attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), or various combinations thereof.

For example, the first model 104 can include at least one GPT model. The GPT model can receive an input sequence, and can parse the input sequence to determine a sequence of tokens (e.g., words or other semantic units of the input sequence, such as by using Byte Pair Encoding tokenization). The GPT model can include or be coupled with a vocabulary of tokens, which can be represented as a one-hot encoding vector, where each token of the vocabulary has a corresponding index in the encoding vector; as such, the GPT model can convert the input sequence into a modified input sequence, such as by applying an embedding matrix to the token tokens of the input sequence (e.g., using a neural network embedding function), and/or applying positional encoding (e.g., sin-cosine positional encoding) to the tokens of the input sequence. The GPT model can process the modified input sequence to determine a next token in the sequence (e.g., to append to the end of the sequence), such as by determining probability scores indicating the likelihood of one or more candidate tokens being the next token, and selecting the next token according to the probability scores (e.g., selecting the candidate token having the highest probability scores as the next token). For example, the GPT model can apply various attention and/or transformer based operations or networks to the modified input sequence to identify relationships between tokens for detecting the next token to form the output sequence.

The first model 104 can include at least one diffusion model, which can be used to generate image and/or video data. For example, the diffusional model can include a denoising neural network and/or a denoising diffusion probabilistic model neural network. The denoising neural network can be configured by applying noise to one or more training data elements (e.g., images, video frames) to generate noised data, providing the noised data as input to a candidate denoising neural network, causing the candidate denoising neural network to modify the noised data according to a denoising schedule, evaluating a convergence condition based on comparing the modified noised data with the training data instances, and modifying the candidate denoising neural network according to the convergence condition (e.g., modifying weights and/or biases of one or more layers of the neural network). In some implementations, the first model 104 includes a plurality of generative models, such as GPT and diffusion models, that can be trained separately or jointly to facilitate generating multi-modal outputs, such as technical documents (e.g., service guides) that include both text and image/video information.

In some implementations, the first model 104 can be configured using various unsupervised and/or supervised training operations. The first model 104 can be configured using training data from various domain-agnostic and/or domain-specific data sources, including but not limited to various forms of text, speech, audio, image, and/or video data, or various combinations thereof. The training data can include a plurality of training data elements (e.g., training data instances). Each training data element can be arranged in structured or unstructured formats; for example, the training data element can include an example output mapped to an example input, such as a query representing a service request or one or more portions of a service request, and a response representing data provided responsive to the query. The training data can include data that is not separated into input and output subsets (e.g., for configuring the first model 104 to perform clustering, classification, or other unsupervised ML operations). The training data can include human-labeled information, including but not limited to feedback regarding outputs of the models 104, 116. This can allow the system 100 to generate more human-like outputs.

In some implementations, the training data includes data relating to building management systems. For example, the training data can include examples of HVAC-R data, such as operating manuals, technical data sheets, configuration settings, operating setpoints, diagnostic guides, troubleshooting guides, user reports, technician reports. In some implementations, the training data used to configure the first model 104 includes at least some publicly accessible data, such as data retrievable via the Internet.

Referring further to FIG. 1, the system 100 can configure the first model 104 to determine one or more second models 116. For example, the system 100 can include a model updater 108 that configures (e.g., trains, updates, modifies, fine-tunes, etc.) the first model 104 to determine the one or more second models 116. In some implementations, the second model 116 can be used to provide application-specific outputs, such as outputs having greater precision, accuracy, or other metrics, relative to the first model, for targeted applications.

The second model 116 can be similar to the first model 104. For example, the second model 116 can have a similar or identical backbone or neural network architecture as the first model 104. In some implementations, the first model 104 and the second model 116 each include generative AI machine learning models, such as LLMs (e.g., GPT-based LLMs) and/or diffusion models. The second model 116 can be configured using processes analogous to those described for configuring the first model 104.

In some implementations, the model updater 108 can perform operations on at least one of the first model 104 or the second model 116 via one or more interfaces, such as application programming interfaces (APIs). For example, the models 104, 116 can be operated and maintained by one or more systems separate from the system 100. The model updater 108 can provide training data to the first model 104, via the API, to determine the second model 116 based on the first model 104 and the training data. The model updater 108 can control various training parameters or hyperparameters (e.g., learning rates, etc.) by providing instructions via the API to manage configuring the second model 116 using the first model 104.

### Data Sources

The model updater 108 can determine the second model 116 using data from one or more data sources 112. For example, the system 100 can determine the second model 116 by modifying the first model 104 using data from the one or more data sources 112. The data sources 112 can include or be coupled with any of a variety of integrated or disparate databases, data warehouses, digital twin data structures (e.g., digital twins of items of equipment or building management systems or portions thereof), data lakes, data repositories, documentation records, or various combinations thereof. In some implementations, the data sources 112 include HVAC-R data in any of text, speech, audio, image, or video data, or various combinations thereof, such as data associated with HVAC-R components and procedures including but not limited to installation, operation, configuration, repair, servicing, diagnostics, and/or troubleshooting of HVAC-R components and systems. Various data described below with reference to data sources 112 may be provided in the same or different data elements, and may be updated at various points. The data sources 112 can include or be coupled with items of equipment (e.g., where the items of equipment output data for the data sources 112, such as sensor data, etc.). The data sources 112 can include various online and/or social media sources, such as blog posts or data submitted to applications maintained by entities that manage the buildings. The system 100 can determine relations between data from different sources, such as by using timeseries information and identifiers of the sites or buildings at which items of equipment are present to detect relationships between various different data relating to the items of equipment (e.g., to train the models 104, 116 using both timeseries data (e.g., sensor data; outputs of algorithms or models, etc.) regarding a given item of equipment and freeform natural language reports regarding the given item of equipment).

The data sources 112 can include unstructured data or structured data (e.g., data that is labeled with or assigned to one or more predetermined fields or identifiers). For example, using the first model 104 and/or second model 116 to process the data can allow the system 100 to extract useful information from data in a variety of formats, including unstructured/freeform formats, which can allow service technicians to input information in less burdensome formats. The data can be of any of a plurality of formats (e.g., text, speech, audio, image, video, etc.), including multi-modal formats. For example, the data may be received from service technicians in forms such as text (e.g., laptop/desktop or mobile application text entry), audio, and/or video (e.g., dictating findings while capturing video).

The data sources 112 can include engineering data regarding one or more items of equipment. The engineering data can include manuals, such as installation manuals, instruction manuals, or operating procedure guides. The engineering data can include specifications or other information regarding operation of items of equipment. The engineering data can include engineering drawings, process flow diagrams, refrigeration cycle parameters (e.g., temperatures, pressures), or various other information relating to structures and functions of items of equipment.

In some implementations, the data sources 112 can include operational data regarding one or more items of equipment. The operational data can represent detected information regarding items of equipment, such as sensor data, logged data, user reports, or technician reports. The operational data can include, for example, service tickets generated responsive to requests for service, work orders, data from digital twin data structures maintained by an entity of the item of equipment, outputs or other information from equipment operation models (e.g., chiller vibration models), or various combinations thereof. Logged data, user reports, service tickets, billing records, time sheets, and various other such data can provide temporal information, such as how long service operations may take, or durations of time between service operations, which can allow the system 100 to predict resources to use for performing service as well as when to request service.

The data sources 112 can include, for instance, warranty data. The warranty data can include warranty documents or agreements that indicate conditions under which various entities associated with items of equipment are to provide service, repair, or other actions corresponding to items of equipment, such as actions corresponding to service requests.

The data sources 112 can include service data. The service data can include data from any of various service providers, such as service reports. The service data can indicate service procedures performed, including associated service procedures with initial service requests and/or sensor data related conditions to trigger service and/or sensor data measured during service processes.

In some implementations, the data sources 112 can include parts data, including but not limited to parts usage and sales data. For example, the data sources 112 can indicate various parts associated with installation or repair of items of equipment. The data sources 112 can indicate tools for performing service and/or installing parts.

The system 100 can include, with the data of the data sources 112, labels to facilitate cross-reference between items of data that may relate to common items of equipment, sites, service technicians, customers, or various combinations thereof. For example, data from disparate sources may be labeled with time data, which can allow the system 100 (e.g., by configuring the models 104, 116) to increase a likelihood of associating information from the disparate sources due to the information being detected or recorded (e.g., as service reports) at the same time or near in time.

For example, the data sources 112 can include data that can be particular to specific or similar items of equipment, buildings, equipment configurations, environmental states, or various combinations thereof. In some implementations, the data includes labels or identifiers of such information, such as to indicate locations, weather conditions, timing information, uses of the items of equipment or the buildings or sites at which the items of equipment are present, etc. This can allow the models 104, 116 to detect patterns of usage (e.g., spikes; troughs; seasonal or other temporal patterns) or other information that may be useful for determining causes of issues or causes of service requests, or predict future issues, such as to allow the models 104, 116 to be trained using information indicative of causes of issues across multiple items of equipment (which may have the same or similar causes even if the data regarding the items of equipment is not identical). For example, an item of equipment may be at a site that is a museum; by relating site usage or occupancy data with data regarding the item of equipment, such as sensor data and service reports, the system 100 can configure the models 104, 116 to determine a high likelihood of issues occurring before events associated with high usage (e.g., gala, major exhibit opening), and can generate recommendations to perform diagnostics or servicing prior to the events.

### Model Configuration

Referring further to FIG. 1, the model updater 108 can perform various machine learning model configuration/training operations to determine the second models 116 using the data from the data sources 112. For example, the model updater 108 can perform various updating, optimization, retraining, reconfiguration, fine-tuning, or transfer learning operations, or various combinations thereof, to determine the second models 116. The model updater 108 can configure the second models 116, using the data sources 112, to generate outputs (e.g., completions) in response to receiving inputs (e.g., prompts), where the inputs and outputs can be analogous to data of the data sources 112.

For example, the model updater 108 can identify one or more parameters (e.g., weights and/or biases) of one or more layers of the first model 104, and maintain (e.g., freeze, maintain as the identified values while updating) the values of the one or more parameters of the one or more layers. In some implementations, the model updater 108 can modify the one or more layers, such as to add, remove, or change an output layer of the one or more layers, or to not maintain the values of the one or more parameters. The model updater 108 can select at least a subset of the identified one or parameters to maintain according to various criteria, such as user input or other instructions indicative of an extent to which the first model 104 is to be modified to determine the second model 116. In some implementations, the model updater 108 can modify the first model 104 so that an output layer of the first model 104 corresponds to output to be determined for applications 120.

Responsive to selecting the one or more parameters to maintain, the model updater 108 can apply, as input to the second model 116 (e.g., to a candidate second model 116, such as the modified first model 104, such as the first model 104 having the identified parameters maintained as the identified values), training data from the data sources 112. For example, the model updater 108 can apply the training data as input to the second model 116 to cause the second model 116 to generate one or more candidate outputs.

The model updater 108 can evaluate a convergence condition to modify the candidate second model 116 based at least on the one or more candidate outputs and the training data applied as input to the candidate second model 116. For example, the model updater 108 can evaluate an objective function of the convergence condition, such as a loss function (e.g., L1 loss, L2 loss, root mean square error, cross-entropy or log loss, etc.) based on the one or more candidate outputs and the training data; this evaluation can indicate how closely the candidate outputs generated by the candidate second model 116 correspond to the ground truth represented by the training data. The model updater 108 can use any of a variety of optimization algorithms (e.g., gradient descent, stochastic descent, Adam optimization, etc.) to modify one or more parameters (e.g., weights or biases of the layer(s) of the candidate second model 116 that are not frozen) of the candidate second model 116 according to the evaluation of the objective function. In some implementations, the model updater 108 can use various hyperparameters to evaluate the convergence condition and/or perform the configuration of the candidate second model 116 to determine the second model 116, including but not limited to hyperparameters such as learning rates, numbers of iterations or epochs of training, etc.

As described further herein with respect to applications 120, in some implementations, the model updater 108 can select the training data from the data of the data sources 112 to apply as the input based at least on a particular application of the plurality of applications 120 for which the second model 116 is to be used for. For example, the model updater 108 can select data from the parts data source 112 for the product recommendation generator application 120, or select various combinations of data from the data sources 112 (e.g., engineering data, operational data, and service data) for the service recommendation generator application 120. The model updater 108 can apply various combinations of data from various data sources 112 to facilitate configuring the second model 116 for one or more applications 120.

In some implementations, the system 100 can perform at least one of conditioning, classifier-based guidance, or classifier-free guidance to configure the second model 116 using the data from the data sources 112. For example, the system 100 can use classifiers associated with the data, such as identifiers of the item of equipment, a type of the item of equipment, a type of entity operating the item of equipment, a site at which the item of equipment is provided, or a history of issues at the site, to condition the training of the second model 116. For example, the system 100 combine (e.g., concatenate) various such classifiers with the data for inputting to the second model 116 during training, for at least a subset of the data used to configure the second model 116, which can facilitate the second model 116 to be responsive to analogous information for runtime/inference time operations.

### Applications

Referring further to FIG. 1, the system 100 can use outputs of the one or more second models 116 to implement one or more applications 120. For example, the second models 116, having been configured using data from the data sources 112, can be capable of precisely generating outputs that represent useful, timely, and/or real-time information for the applications 120. In some implementations, each application 120 is coupled with a corresponding second model 116 that is specifically configured to generate outputs for use by the application 120. Various applications 120 can be coupled with one another, such as to provide outputs from a first application 120 as inputs or portions of inputs to a second application 120.

The applications 120 can include any of a variety of desktop, web-based/browser-based, or mobile applications. For example, the applications 120 can be implemented by enterprise management software systems, employee or other user applications (e.g., applications that relate to BMS functionality such as temperature control, user preferences, conference room scheduling, etc.), equipment portals that provide data regarding items of equipment, or various combinations thereof. The applications 120 can include user interfaces, wizards, checklists, conversational interfaces, chatbots, configuration tools, or various combinations thereof. The applications 120 can receive an input, such as a prompt (e.g., from a user), provide the prompt to the second model 116 to cause the second model 116 to generate an output, such as a completion in response to the prompt, and present an indication of the output. The applications 120 can receive inputs and/or present outputs in any of a variety of presentation modalities, such as text, speech, audio, image, and/or video modalities. For example, the applications 120 can receive unstructured or freeform inputs from a user, such as a service technician, and generate reports in a standardized format, such as a customer-specific format. This can allow, for example, technicians to automatically, and flexibly, generate customer-ready reports after service visits without requiring strict input by the technician or manually sitting down and writing reports; to receive inputs as dictations in order to generate reports; to receive inputs in any form or a variety of forms, and use the second model 116 (which can be trained to cross-reference metadata in different portions of inputs and relate together data elements) to generate output reports (e.g., the second model 116, having been configured with data that includes time information, can use timestamps of input from dictation and timestamps of when an image is taken, and place the image in the report in a target position or label based on time correlation).

In some implementations, the applications 120 include at least one virtual assistant (e.g., virtual assistance for technician services) application 120. The virtual assistant application can provide various services to support technician operations, such as presenting information from service requests, receiving queries regarding actions to perform to service items of equipment, and presenting responses indicating actions to perform to service items of equipment. The virtual assistant application can receive information regarding an item of equipment to be serviced, such as sensor data, text descriptions, or camera images, and process the received information using the second model 116 to generate corresponding responses.

For example, the virtual assistant application 120 can be implemented in a UI/UX wizard configuration, such as to provide a sequence of requests for information from the user (the sequence may include requests that are at least one of predetermined or dynamically generated responsive to inputs from the user for previous requests). For example, the virtual assistant application 120 can provide one or more requests for users such as service technicians, facility managers, or other occupants, and provide the received responses to at least one of the second model 116 or a root cause detection function (e.g., algorithm, model, data structure mapping inputs to candidate causes, etc.) to determine a prediction of a cause of the issue of the item of equipment and/or solutions. The virtual assistant application 120 can use requests for information such as for unstructured text by which the user describes characteristics of the item of equipment relating to the issue; answers expected to correspond to different scenarios indicative of the issue; and/or image and/or video input (e.g., images of problems, equipment, spaces, etc. that can provide more context around the issue and/or configurations). For example, responsive to receiving a response via the virtual assistant application 120 indicating that the problem is with temperature in the space, the system 100 can request, via the virtual assistant application 120, information regarding HVAC-R equipment associated with the space, such as pictures of the space, an air handling unit, a chiller, or various combinations thereof.

The virtual assistant application 120 can include a plurality of applications 120 (e.g., variations of interfaces or customizations of interfaces) for a plurality of respective user types. For example, the virtual assistant application 120 can include a first application 120 for a customer user, and a second application 120 for a service technician user. The virtual assistant applications 120 can allow for updating and other communications between the first and second applications 120 as well as the second model 116. Using one or more of the first application 120 and the second application 120, the system 100 can manage continuous/real-time conversations for one or more users, and evaluate the users' engagement with the information provided (e.g., did the user, customer, service technician, etc., follow the provided steps for responding to the issue or performing service, did the user discontinue providing inputs to the virtual assistant application 120, etc.), such as to allow the system 100 to update the information generated by the second model 116 for the virtual assistant application 120 according to the engagement. In some implementations, the system 100 can use the second model 116 to detect sentiment of the user of the virtual assistant application 120, and update the second model 116 according to the detected sentiment, such as to improve the experience provided by the virtual assistant application 120.

The applications 120 can include at least one document writer application 120, such as a technical document writer. The document writer application 120 can facilitate preparing structured (e.g., form-based) and/or unstructured documentation, such as documentation associated with service requests. For example, the document writer application 120 can present a user interface corresponding to a template document to be prepared that is associated with at least one of a service request or the item of equipment for which the service request is generated, such as to present one or more predefined form sections or fields. The document writer application 120 can use inputs, such as prompts received from the users and/or technical data provided by the user regarding the item of equipment, such as sensor data, text descriptions, or camera images, to generate information to include in the documentation. For example, the document writer application 120 can provide the inputs to the second model 116 to cause the second model 116 to generate completions for text information to include in the fields of the documentation.

The applications 120 can include, in some implementations, at least one diagnostics and troubleshooting application 120. The diagnostics and troubleshooting application 120 can receive inputs including at least one of a service request or information regarding the item of equipment to be serviced, such as information identified by a service technician. The diagnostics and troubleshooting application 120 can provide the inputs to a corresponding second model 116 to cause the second model 116 to generate outputs such as indications of potential items to be checked regarding the item of equipment, modifications or fixes to make to perform the service, or values or ranges of values of parameters of the item of equipment that may be indicative of specific issues to for the service technician to address or repair.

The applications 120 can at least one service recommendation generator application 120. The service recommendation generator application 120 can receive inputs such as a service request or information regarding the item of equipment to be serviced, and provide the inputs to the second model 116 to cause the second model 116 to generate outputs for presenting service recommendations, such as actions to perform to address the service request.

In some implementations, the applications 120 can include a product recommendation generator application 120. The product recommendation generator application 120 can process inputs such as information regarding the item of equipment or the service request, using one or more second models 116 (e.g., models trained using parts data from the data sources 112), to determine a recommendation of a part or product to replace or otherwise use for repairing the item of equipment.

### Feedback Training

Referring further to FIG. 1, the system 100 can include at least one feedback trainer 128 coupled with at least one feedback repository 124. The system 100 can use the feedback trainer 128 to increase the precision and/or accuracy of the outputs generated by the second models 116 according to feedback provided by users of the system 100 and/or the applications 120.

The feedback repository 124 can include feedback received from users regarding output presented by the applications 120. For example, for at least a subset of outputs presented by the applications 120, the applications 120 can present one or more user input elements for receiving feedback regarding the outputs. The user input elements can include, for example, indications of binary feedback regarding the outputs (e.g., good/bad feedback; feedback indicating the outputs do or do not meet the user's criteria, such as criteria regarding technical accuracy or precision); indications of multiple levels of feedback (e.g., scoring the outputs on a predetermined scale, such as a 1-5 scale or 1-10 scale); freeform feedback (e.g., text or audio feedback); or various combinations thereof.

The system 100 can store and/or maintain feedback in the feedback repository 124. In some implementations, the system 100 stores the feedback with one or more data elements associated with the feedback, including but not limited to the outputs for which the feedback was received, the second model(s) 116 used to generate the outputs, and/or input information used by the second models 116 to generate the outputs (e.g., service request information; information captured by the user regarding the item of equipment).

The feedback trainer 128 can update the one or more second models 116 using the feedback. The feedback trainer 128 can be similar to the model updater 108. In some implementations, the feedback trainer 128 is implemented by the model updater 108; for example, the model updater 108 can include or be coupled with the feedback trainer 128. The feedback trainer 128 can perform various configuration operations (e.g., retraining, fine-tuning, transfer learning, etc.) on the second models 116 using the feedback from the feedback repository 124. In some implementations, the feedback trainer 128 identifies one or more first parameters of the second model 116 to maintain as having predetermined values (e.g., freeze the weights and/or biases of one or more first layers of the second model 116), and performs a training process, such as a fine tuning process, to configure parameters of one or more second parameters of the second model 116 using the feedback (e.g., one or more second layers of the second model 116, such as output layers or output heads of the second model 116).

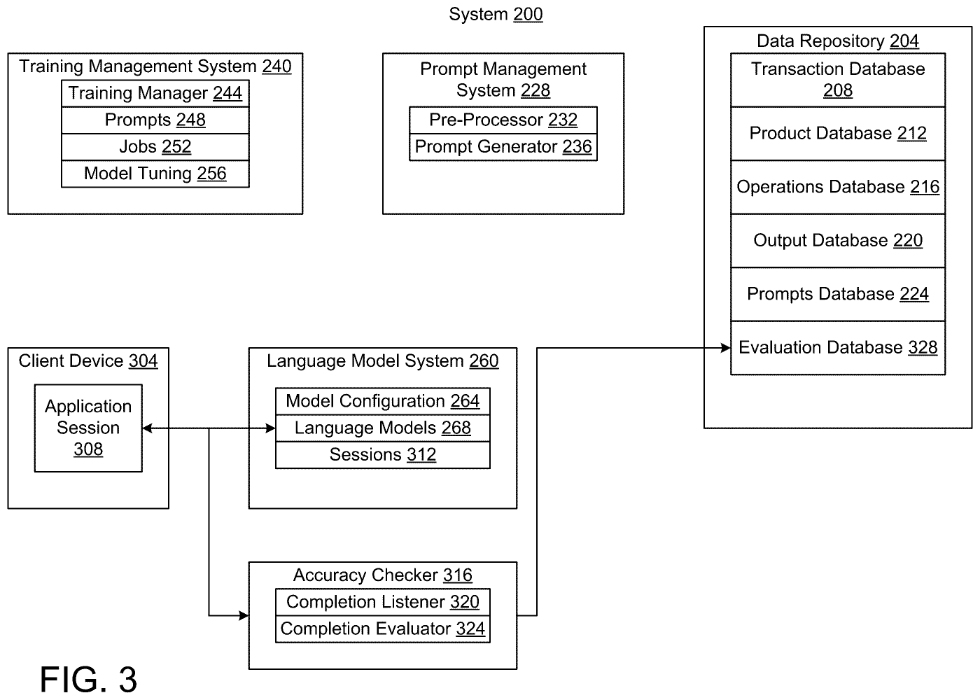

In some implementations, the system 100 may not include and/or use the model updater 108 (or the feedback trainer 128) to determine the second models 116. For example, the system 100 can include or be coupled with an output processor (e.g., an output processor similar or identical to accuracy checker 316 described with reference to FIG. 3) that can evaluate and/or modify outputs from the first model 104 prior to operation of applications 120, including to perform any of various post-processing operations on the output from the first model 104. For example, the output processor can compare outputs of the first model 104 with data from data sources 112 to validate the outputs of the first model 104 and/or modify the outputs of the first model 104 (or output an error) responsive to the outputs not satisfying a validation condition.

### Connected Machine Learning Models

Referring further to FIG. 1, the second model 116 can be coupled with one or more third models, functions, or algorithms for training/configuration and/or runtime operations. The third models can include, for example and without limitation, any of various models relating to items of equipment, such as energy usage models, sustainability models, carbon models, air quality models, or occupant comfort models. For example, the second model 116 can be used to process unstructured information regarding items of equipment into predefined template formats compatible with various third models, such that outputs of the second model 116 can be provided as inputs to the third models; this can allow more accurate training of the third models, more training data to be generated for the third models, and/or more data available for use by the third models. The second model 116 can receive inputs from one or more third models, which can provide greater data to the second model 116 for processing.

### Automated Service Scheduling and Provisioning

The system 100 can be used to automate operations for scheduling, provisioning, and deploying service technicians and resources for service technicians to perform service operations. For example, the system 100 can use at least one of the first model 104 or the second model 116 to determine, based on processing information regarding service operations for items of equipment relative to completion criteria for the service operation, particular characteristics of service operations such as experience parameters of scheduled service technicians, identifiers of parts provided for the service operations, geographical data, types of customers, types of problems, or information content provided to the service technicians to facilitate the service operation, where such characteristics correspond to the completion criteria being satisfied (e.g., where such characteristics correspond to an increase in likelihood of the completion criteria being satisfied relative to other characteristics for service technicians, parts, information content, etc.). For example, the system 100 can determine, for a given item of equipment, particular parts to include on a truck to be sent to the site of the item of equipment. As such, the system 100, responsive to processing inputs at runtime such as service requests, can automatically and more accurately identify service technicians and parts to direct to the item of equipment for the service operations. The system 100 can use timing information to perform batch scheduling for multiple service operations and/or multiple technicians for the same or multiple service operations. The system 100 can perform batch scheduling for multiple trucks for multiple items of equipment, such as to schedule a first one or more parts having a greater likelihood for satisfying the completion criteria for a first item of equipment on a first truck, and a second one or more parts having a greater likelihood for satisfying the completion criteria for a second item of equipment on a second truck.

### II. System Architectures for Generative AI Applications for Building Management System and Equipment Servicing

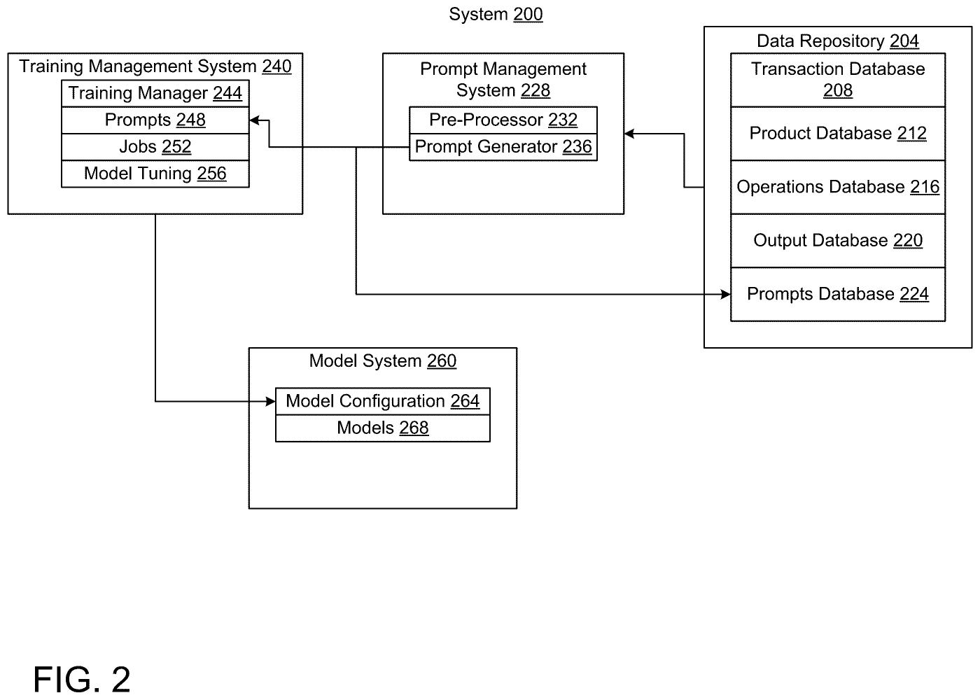

FIG. 2 depicts an example of a system 200. The system 200 can include one or more components or features of the system 100, such as any one or more of the first model 104, data sources 112, second model 116, applications 120, feedback repository 124, and/or feedback trainer 128. The system 200 can perform specific operations to facilitate generative AI applications for building managements systems and equipment servicing, such as various manners of processing input data into training data (e.g., tokenizing input data; forming input data into prompts and/or completions), and managing training and other machine learning model configuration processes. Various components of the system 200 can be implemented using one or more computer systems, which may be provided on the same or different processors (e.g., processors communicatively coupled via wired and/or wireless connections).

The system 200 can include at least one data repository 204, which can be similar to the data sources 112 described with reference to FIG. 1. For example, the data repository 204 can include a transaction database 208, which can be similar or identical to one or more of warranty data or service data of data sources 112. For example, the transaction database 208 can include data such as parts used for service transactions; sales data indicating various service transactions or other transactions regarding items of equipment; warranty and/or claims data regarding items of equipment; and service data.

The data repository 204 can include a product database 212, which can be similar or identical to the parts data of the data sources 112. The product database 212 can include, for example, data regarding products available from various vendors, specifications or parameters regarding products, and indications of products used for various service operations. The products database 212 can include data such as events or alarms associated with products; logs of product operation; and/or time series data regarding product operation, such as longitudinal data values of operation of products and/or building equipment.

The data repository 204 can include an operations database 216, which can be similar or identical to the operations data of the data sources 112. For example, the operations database 216 can include data such as manuals regarding parts, products, and/or items of equipment; customer service data; and or reports, such as operation or service logs.

In some implementations, the data repository 204 can include an output database 220, which can include data of outputs that may be generated by various machine learning models and/or algorithms. For example, the output database 220 can include values of pre-calculated predictions and/or insights, such as parameters regarding operation items of equipment, such as setpoints, changes in setpoints, flow rates, control schemes, identifications of error conditions, or various combinations thereof.

As depicted in FIG. 2, the system 200 can include a prompt management system 228. The prompt management system 228 can include one or more rules, heuristics, logic, policies, algorithms, functions, machine learning models, neural networks, scripts, or various combinations thereof to perform operations including processing data from data repository 204 into training data for configuring various machine learning models. For example, the prompt management system 228 can retrieve and/or receive data from the data repository 228, and determine training data elements that include examples of input and outputs for generation by machine learning models, such as a training data element that includes a prompt and a completion corresponding to the prompt, based on the data from the data repository 228.

In some implementations, the prompt management system 228 includes a pre-processor 232. The pre-processor 232 can perform various operations to prepare the data from the data repository 204 for prompt generation. For example, the pre-processor 232 can perform any of various filtering, compression, tokenizing, or combining (e.g., combining data from various databases of the data repository 204) operations.

The prompt management system 228 can include a prompt generator 236. The prompt generator 236 can generate, from data of the data repository 204, one or more training data elements that include a prompt and a completion corresponding to the prompt. In some implementations, the prompt generator 236 receives user input indicative of prompt and completion portions of data. For example, the user input can indicate template portions representing prompts of structured data, such as predefined fields or forms of documents, and corresponding completions provided for the documents. The user input can assign prompts to unstructured data. In some implementations, the prompt generator 236 automatically determines prompts and completions from data of the data repository 204, such as by using any of various natural language processing algorithms to detect prompts and completions from data. In some implementations, the system 200 does not identify distinct prompts and completions from data of the data repository 204.

Referring further to FIG. 2, the system 200 can include a training management system 240. The training management system 240 can include one or more rules, heuristics, logic, policies, algorithms, functions, machine learning models, neural networks, scripts, or various combinations thereof to perform operations including controlling training of machine learning models, including performing fine tuning and/or transfer learning operations.

The training management system 240 can include a training manager 244. The training manager 244 can incorporate features of at least one of the model updater 108 or the feedback trainer 128 described with reference to FIG. 1. For example, the training manager 244 can provide training data including a plurality of training data elements (e.g., prompts and corresponding completions) to the model system 260 as described further herein to facilitate training machine learning models.

In some implementations, the training management system 240 includes a prompts database 248. For example, the training management system 240 can store one or more training data elements from the prompt management system 228, such as to facilitate asynchronous and/or batched training processes.

The training manager 244 can control the training of machine learning models using information or instructions maintained in a model tuning database 256. For example, the training manager 244 can store, in the model tuning database 256, various parameters or hyperparameters for models and/or model training.

In some implementations, the training manager 244 stores a record of training operations in a jobs database 252. For example, the training manager 244 can maintain data such as a queue of training jobs, parameters or hyperparameters to be used for training jobs, or information regarding performance of training.

Referring further to FIG. 2, the system 200 can include at least one model system 260 (e.g., one or more language model systems). The model system 260 can include one or more rules, heuristics, logic, policies, algorithms, functions, machine learning models, neural networks, scripts, or various combinations thereof to perform operations including configuring one or more machine learning models 268 based on instructions from the training management system 240. In some implementations, the training management system 240 implements the model system 260. In some implementations, the training management system 240 can access the model system 260 using one or more APIs, such as to provide training data and/or instructions for configuring machine learning models 268 via the one or more APIs. The model system 260 can operate as a service layer for configuring the machine learning models 268 responsive to instructions from the training management system 240. The machine learning models 268 can be or include the first model 104 and/or second model 116 described with reference to FIG. 1.

The model system 260 can include a model configuration processor 264. The model configuration processor 264 can incorporate features of the model updater 108 and/or the feedback trainer 128 described with reference to FIG. 1. For example, the model configuration processor 264 can apply training data (e.g., prompts 248 and corresponding completions) to the machine learning models 268 to configure (e.g., train, modify, update, fine-tune, etc.) the machine learning models 268. The training manager 244 can control training by the model configuration processor 264 based on model tuning parameters in the model tuning database 256, such as to control various hyperparameters for training. In various implementations, the system 200 can use the training management system 240 to configure the machine learning models 268 in a similar manner as described with reference to the second model 116 of FIG. 1, such as to train the machine learning models 268 using any of various data or combinations of data from the data repository 204.

### Application Session Management

FIG. 3 depicts an example of the system 200, in which the system 200 can perform operations to implement at least one application session 308 for a client device 304. For example, responsive to configuring the machine learning models 268, the system 200 can generate data for presentation by the client device 304 (including generating data responsive to information received from the client device 304) using the at least one application session 308 and the one or more machine learning models 268.

The client device 304 can be a device of a user, such as a technician or building manager. The client device 304 can include any of various wireless or wired communication interfaces to communicate data with the model system 260, such as to provide requests to the model system 260 indicative of data for the machine learning models 268 to generate, and to receive outputs from the model system 260. The client device 304 can include various user input and output devices to facilitate receiving and presenting inputs and outputs.

In some implementations, the system 200 provides data to the client device 304 for the client device 304 to operate the at least one application session 308. The application session 308 can include a session corresponding to any of the applications 120 described with reference to FIG. 1. For example, the client device 304 can launch the application session 308 and provide an interface to request one or more prompts. Responsive to receiving the one or more prompts, the application session 308 can provide the one or more prompts as input to the machine learning model 268. The machine learning model 268 can process the input to generate a completion, and provide the completion to the application session 308 to present via the client device 304. In some implementations, the application session 308 can iteratively generate completions using the machine learning models 268. For example, the machine learning models 268 can receive a first prompt from the application session 308, determine a first completion based on the first prompt and provide the first completion to the application session 308, receive a second prompt from the application 308, determine a second completion based on the second prompt (which may include at least one of the first prompt or the first completion concatenated to the second prompt), and provide the second completion to the application session 308.

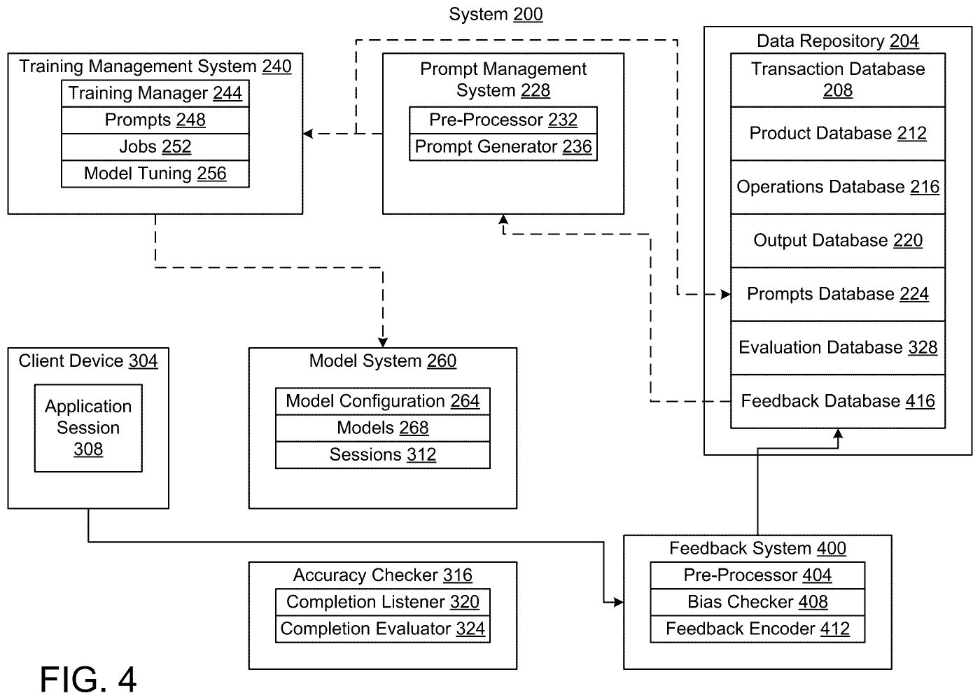

In some implementations, the model system 260 includes at least one sessions database 312. The sessions database 312 can maintain records of application session 308 implemented by client devices 304. For example, the sessions database 312 can include records of prompts provided to the machine learning models 268 and completions generated by the machine learning models 268. As described further with reference to FIG. 4, the system 200 can use the data in the sessions database 312 to fine-tune or otherwise update the machine learning models 268.

### Completion Checking

In some implementations, the system 200 includes an accuracy checker 316. The accuracy checker 316 can include one or more rules, heuristics, logic, policies, algorithms, functions, machine learning models, neural networks, scripts, or various combinations thereof to perform operations including evaluating performance criteria regarding the completions determined by the model system 260. For example, the accuracy checker 316 can include at least one completion listener 320. The completion listener 320 can receive the completions determined by the model system 320 (e.g., responsive to the completions being generated by the machine learning model 268 and/or by retrieving the completions from the sessions database 312).

The accuracy checker 316 can include at least one completion evaluator 324. The completion evaluator 324 can evaluate the completions (e.g., as received or retrieved by the completion listener 320) according to various criteria. In some implementations, the completion evaluator 324 evaluates the completions by comparing the completions with corresponding data from the data repository 204. For example, the completion evaluator 324 can identify data of the data repository 204 having similar text as the prompts and/or completions (e.g., using any of various natural language processing algorithms), and determine whether the data of the completions is within a range of expected data represented by the data of the data repository 204.

In some implementations, the accuracy checker 316 can store an output from evaluating the completion (e.g., an indication of whether the completion satisfies the criteria) in an evaluation database 328. For example, the accuracy checker 316 can assign the output (which may indicate at least one of a binary indication of whether the completion satisfied the criteria or an indication of a portion of the completion that did not satisfy the criteria) to the completion for storage in the evaluation database 328, which can facilitate further training of the machine learning models 268 using the completions and output.

### Feedback Training

FIG. 4 depicts an example of the system 200 that includes a feedback system 400, such as a feedback aggregator. The feedback system 400 can include one or more rules, heuristics, logic, policies, algorithms, functions, machine learning models, neural networks, scripts, or various combinations thereof to perform operations including preparing data for updating and/or updating the machine learning models 268 using feedback corresponding to the application sessions 308, such as feedback received as user input associated with outputs presented by the application sessions 308. The feedback system 400 can incorporate features of the feedback repository 124 and/or feedback trainer 128 described with reference to FIG. 1.

The feedback system 400 can receive feedback (e.g., from the client device 304) in various formats. For example, the feedback can include any of text, speech, audio, image, and/or video data. The feedback can be associated (e.g., in a data structure generated by the application session 308) with the outputs of the machine learning models 268 for which the feedback is provided. The feedback can be received or extracted from various forms of data, including external data sources such as manuals, service reports, or Wikipedia-type documentation.

In some implementations, the feedback system 400 includes a pre-processor 400. The pre-processor 400 can perform any of various operations to modify the feedback for further processing. For example, the pre-processor 400 can incorporate features of, or be implemented by, the pre-processor 232, such as to perform operations including filtering, compression, tokenizing, or translation operations (e.g., translation into a common language of the data of the data repository 204).

The feedback system 400 can include a bias checker 408. The bias checker 408 can evaluate the feedback using various bias criteria, and control inclusion of the feedback in a feedback database 416 (e.g., a feedback database 416 of the data repository 204 as depicted in FIG. 4) according to the evaluation. The bias criteria can include, for example and without limitation, criteria regarding qualitative and/or quantitative differences between a range or statistic measure of the feedback relative to actual, expected, or validated values.

The feedback system 400 can include a feedback encoder 412. The feedback encoder 412 can process the feedback (e.g., responsive to bias checking by the bias checker 408) for inclusion in the feedback database 416. For example, the feedback encoder 412 can encode the feedback as values corresponding to outputs scoring determined by the model system 260 while generating completions (e.g., where the feedback indicates that the completion presented via the application session 308 was acceptable, the feedback encoder 412 can encode the feedback by associating the feedback with the completion and assigning a relatively high score to the completion).

As indicated by the dashed arrows in FIG. 4, the feedback can be used by the prompt management system 228 and training management system 240 to further update one or more machine learning models 268. For example, the prompt management system 228 can retrieve at least one feedback (and corresponding prompt and completion data) from the feedback database 416, and process the at least one feedback to determine a feedback prompt and feedback completion to provide to the training management system 240 (e.g., using pre-processor 232 and/or prompt generator 236, and assigning a score corresponding to the feedback to the feedback completion). The training manager 244 can provide instructions to the model system 260 to update the machine learning models 268 using the feedback prompt and the feedback completion, such as to perform a fine-tuning process using the feedback prompt and the feedback completion. In some implementations, the training management system 240 performs a batch process of feedback-based fine tuning by using the prompt management system 228 to generate a plurality of feedback prompts and a plurality of feedback completion, and providing instructions to the model system 260 to perform the fine-tuning process using the plurality of feedback prompts and the plurality of feedback completions.

### Data Filtering and Validation Systems

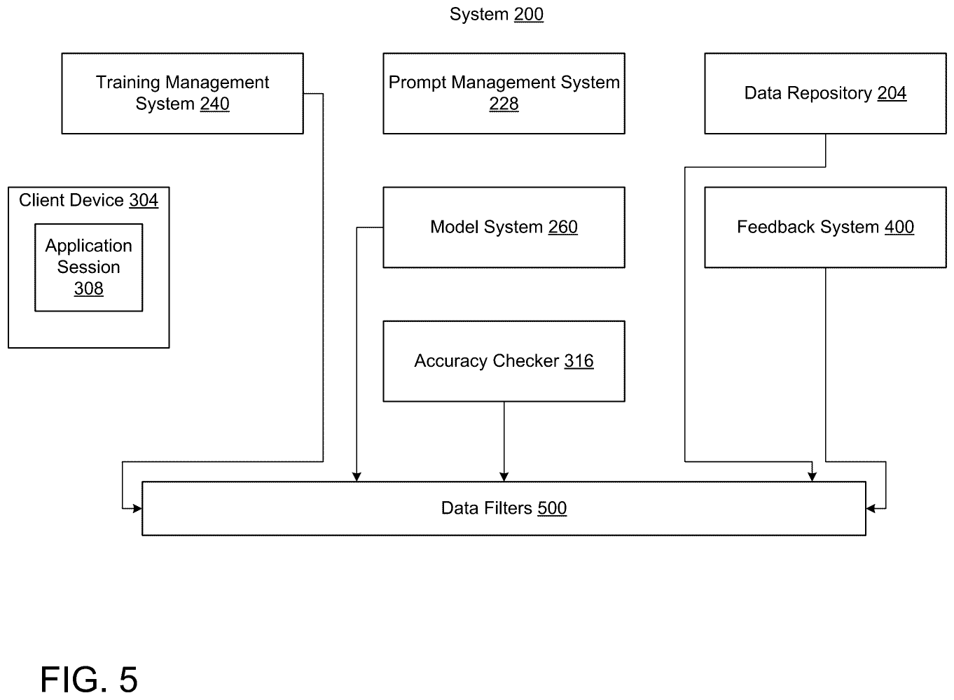

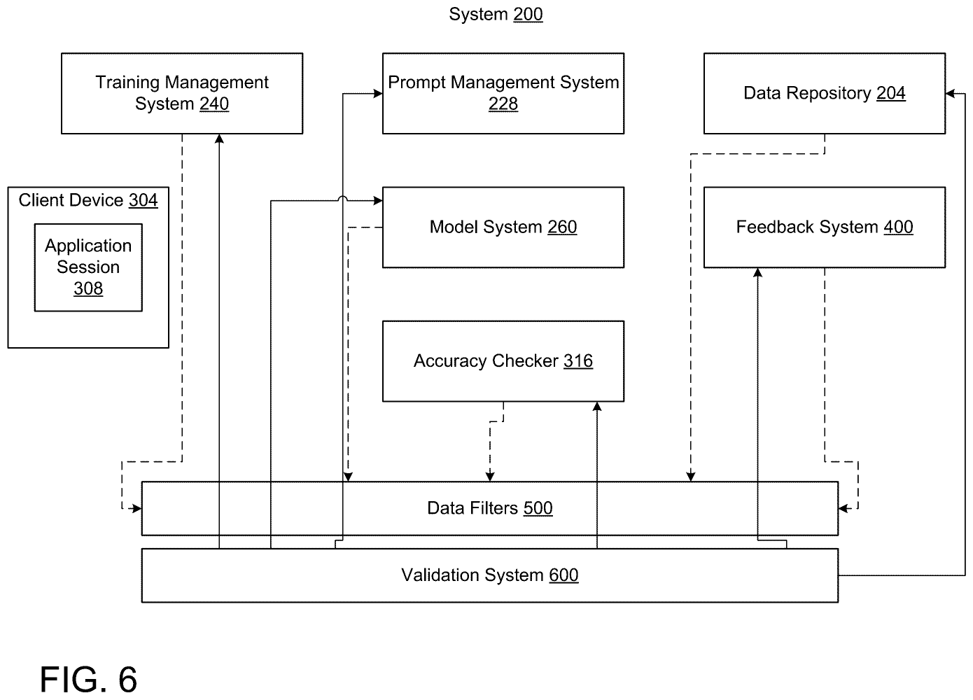

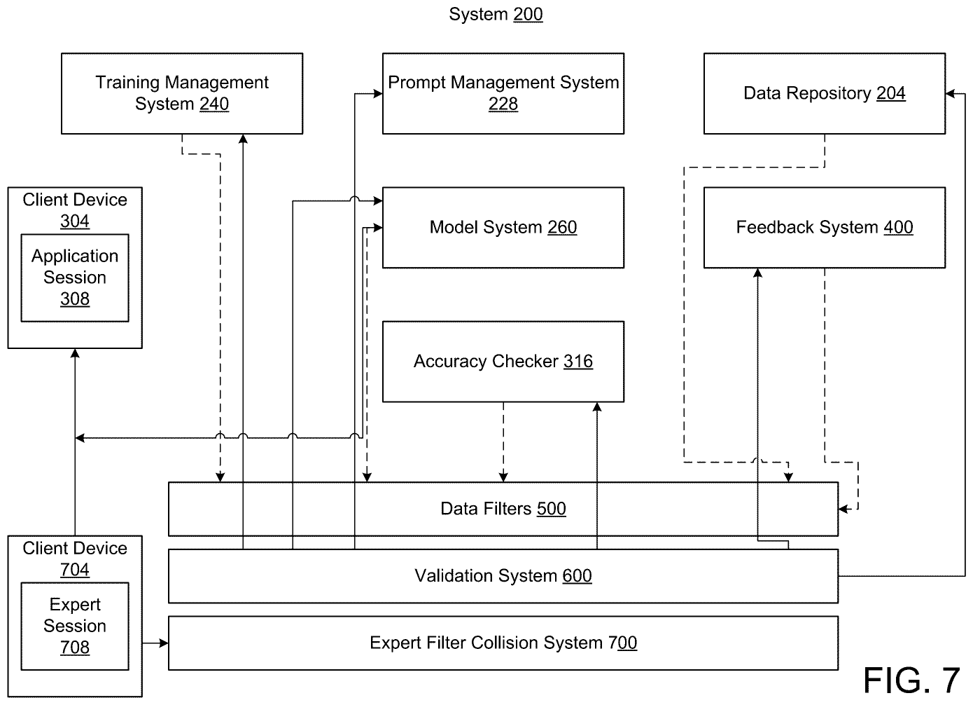

FIG. 5 depicts an example of the system 200, where the system 200 can include one or more data filters 500 (e.g., data validators). The data filters 500 can include any one or more rules, heuristics, logic, policies, algorithms, functions, machine learning models, neural networks, scripts, or various combinations thereof to perform operations including modifying data processed by the system 200 and/or triggering alerts responsive to the data not satisfying corresponding criteria, such as thresholds for values of data. Various data filtering processes described with reference to FIG. 5 (as well as FIGS. 6 and 7) can provide system 200 to implement timely operations for improving the precision and/or accuracy of completions or other information generated by the system 200 (e.g., including improving the accuracy of feedback data used for fine-tuning the machine learning models 268). The data filters 500 can allow for interactions between various algorithms, models, and computational processes.

For example, the data filters 500 can be used to evaluate data relative to thresholds relating to data including, for example and without limitation, acceptable data ranges, setpoints, temperatures, pressures, flow rates (e.g., mass flow rates), or vibration rates for an item of equipment. The threshold can include any of various thresholds, such as one or more of minimum, maximum, absolute, relative, fixed band, and/or floating band thresholds.

The data filters 500 can allow the system 200 to detect when data, such as prompts, completions, or other inputs and/or outputs of the system 200, collide with thresholds that represent realistic behavior or operation or other limits of items of equipment. For example, the thresholds of the data filters 500 can correspond to values of data that are within feasible or recommended operating ranges. In some implementations, the system 200 determines or receives the thresholds using models or simulations of items of equipment, such as plant or equipment simulators, chiller models, HVAC-R models, refrigeration cycle models, etc. The system 200 can receive the thresholds as user input (e.g., from experts, technicians, or other users). The thresholds of the data filters 500 can be based on information from various data sources. The thresholds can include, for example and without limitation, thresholds based on information such as equipment limitations, safety margins, physics, expert teaching, etc. For example, the data filters 500 can include thresholds determined from various models, functions, or data structures (e.g., tables) representing physical properties and processes, such as physics of psychometrics, thermodynamics, and/or fluid dynamics information.

The system 200 can determine the thresholds using the feedback system 400 and/or the client device 304, such as by providing a request for feedback that includes a request for a corresponding threshold associated with the completion and/or prompt presented by the application session 308. For example, the system 200 can use the feedback to identify realistic thresholds, such as by using feedback regarding data generated by the machine learning models 268 for ranges, setpoints, and/or start-up or operating sequences regarding items of equipment (and which can thus be validated by human experts). In some implementations, the system 200 selectively requests feedback indicative of thresholds based on an identifier of a user of the application session 308, such as to selectively request feedback from users having predetermined levels of expertise and/or assign weights to feedback according to criteria such as levels of expertise.

In some implementations, one or more data filters 500 correspond to a given setup. For example, the setup can represent a configuration of a corresponding item of equipment (e.g., configuration of a chiller, etc.). The data filters 500 can represent various thresholds or conditions with respect to values for the configuration, such as feasible or recommendation operating ranges for the values. In some implementations, one or more data filters 500 correspond to a given situation. For example, the situation can represent at least one of an operating mode or a condition of a corresponding item of equipment.

FIG. 5 depicts some examples of data (e.g., inputs, outputs, and/or data communicated between nodes of machine learning models 268) to which the data filters 500 can be applied to evaluate data processed by the system 200 including various inputs and outputs of the system 200 and components thereof. This can include, for example and without limitation, filtering data such as data communicated between one or more of the data repository 204, prompt management system 228, training management system 240, model system 260, client device 304, accuracy checker 316, and/or feedback system 400. For example, the data filters 500 (as well as validation system 600 described with reference to FIG. 6 and/or expert filter collision system 700 described with reference to FIG. 7) can receive data outputted from a source (e.g., source component) of the system 200 for receipt by a destination (e.g., destination component) of the system 200, and filter, modify, or otherwise process the outputted data prior to the system 200 providing the outputted data to the destination. The sources and destinations can include any of various combinations of components and systems of the system 200.

The system 200 can perform various actions responsive to the processing of data by the data filters 500. In some implementations, the system 200 can pass data to a destination without modifying the data (e.g., retaining a value of the data prior to evaluation by the data filter 500) responsive to the data satisfying the criteria of the respective data filter(s) 500. In some implementations, the system 200 can at least one of (i) modify the data or (ii) output an alert responsive to the data not satisfying the criteria of the respective data filter(s) 500. For example, the system 200 can modify the data by modifying one or more values of the data to be within the criteria of the data filters 500.

In some implementations, the system 200 modifies the data by causing the machine learning models 268 to regenerate the completion corresponding to the data (e.g., for up to a predetermined threshold number of regeneration attempts before triggering the alert). This can facilitate the data filters 500 and the system 200 selectively trigger alerts responsive to determining that the data (e.g., the collision between the data and the thresholds of the data filters 500) may not be repairable by the machine learning model 268 aspects of the system 200.

The system 200 can output the alert to the client device 304. The system 200 can assign a flag corresponding to the alert to at least one of the prompt (e.g., in prompts database 224) or the completion having the data that triggered the alert.

FIG. 6 depicts an example of the system 200, in which a validation system 600 is coupled with one or more components of the system 200, such as to process and/or modify data communicated between the components of the system 200. For example, the validation system 600 can provide a validation interface for human users (e.g., expert supervisors, checkers) and/or expert systems (e.g., data validation systems that can implement processes analogous to those described with reference to the data filters 500) to receive data of the system 200 and modify, validate, or otherwise process the data. For example, the validation system 600 can provide to human expert supervisors, human checkers, and/or expert systems various data of the system 200, receive responses to the provided data indicating requested modifications to the data or validations of the data, and modify (or validate) the provided data according to the responses.

For example, the validation system 600 can receive data such as data retrieved from the data repository 204, prompts outputted by the prompt management system 228, completions outputted by the model system 260, indications of accuracy outputted by the accuracy checker 316, etc., and provide the received data to at least one of an expert system or a user interface. In some implementations, the validation system 600 receives a given item of data prior to the given item of data being processed by the model system 260, such as to validate inputs to the machine learning models 268 prior to the inputs being processed by the machine learning models 268 to generate outputs, such as completions.

In some implementations, the validation system 600 validates data by at least one of (i) assigning a label (e.g., a flag, etc.) to the data indicating that the data is validated or (ii) passing the data to a destination without modifying the data. For example, responsive to receiving at least one of a user input (e.g., from a human validator/supervisor/expert) that the data is valid or an indication from an expert system that the data is valid, the validation system 600 can assign the label and/or provide the data to the destination.

The validation system 600 can selectively provide data from the system 200 to the validation interface responsive to operation of the data filters 500. This can facilitate the validation system 600 to trigger validation of the data responsive to collision of the data with the criteria of the data filters 500. For example, responsive to the data filters 500 determining that an item of data does not satisfy a corresponding criteria, the data filters 500 can provide the item of data to the validation system 600. The data filters 500 can assign various labels to the item of data, such as indications of the values of the thresholds that the data filters 500 used to determine that the item of data did not satisfy the thresholds. Responsive to receiving the item of data from the data filters 500, the validation system 600 can provide the item of data to the validation interface (e.g., to a user interface of client device 304 and/or application session 308; for comparison with a model, simulation, algorithm, or other operation of an expert system) for validation. In some implementations, the validation system 600 can receive an indication that the item of data is valid (e.g., even if the item of data did not satisfy the criteria of the data filters 500) and can provide the indication to the data filters 500 to cause the data filters 500 to at least partially modify the respective thresholds according to the indication.

In some implementations, the validation system 600 selectively retrieves data for validation where (i) the data is determined or outputted prior to use by the machine learning models 268, such as data from the data repository 204 or the prompt management system 228, or (ii) the data does not satisfy a respective data filter 500 that processes the data. This can facilitate the system 200, the data filters 500, and the validation system 600 to update the machine learning models 268 and other machine learning aspects (e.g., generative AI aspects) of the system 200 to more accurately generate data and completions (e.g., enabling the data filters 500 to generate alerts that are received by the human experts/expert systems that may be repairable by adjustments to one or more components of the system 200).

FIG. 7 depicts an example of the system 200, in which an expert filter collision system 700 (“expert system” 700) can facilitate providing feedback and providing more accurate and/or precise data and completions to a user via the application session 308. For example, the expert system 700 can interface with various points and/or data flows of the system 200, as depicted in FIG. 7, where the system 200 can provide data to the expert filter collision system 700, such as to transmit the data to a user interface and/or present the data via a user interface of the expert filter collision system 700 that can accessed via an expert session 708 of a client device 704. For example, via the expert session 708, the expert session 700 can provide functions such as receiving inputs for a human expert to provide feedback to a user of the client device 304; a human expert to guide the user through the data (e.g., completions) provided to the client device 304, such as reports, insights, and action items; a human expert to review and/or provide feedback for revising insights, guidance, and recommendations before being presented by the application session 308; a human expert to adjust and/or validate insights or recommendations before they are viewed or used for actions by the user; or various combinations thereof. In some implementations, the expert system 700 can use feedback received via the expert session as inputs to update the machine learning models 268 (e.g., to perform fine-tuning).

In some implementations, the expert system 700 retrieves data to be provided to the application session 308, such as completions generated by the machine learning models 268. The expert system 700 can present the data via the expert session 708, such as to request feedback regarding the data from the client device 704. For example, the expert system 700 can receive feedback regarding the data for modifying or validating the data (e.g., editing or validating completions). In some implementations, the expert system 700 requests at least one of an identifier or a credential of a user of the client device 704 prior to providing the data to the client device 704 and/or requesting feedback regarding the data from the expert session 708. For example, the expert system 700 can request the feedback responsive to determining that the at least one of the identifier or the credential satisfies a target value for the data. This can allow the expert system 708 to selectively identify experts to use for monitoring and validating the data.

In some implementations, the expert system 700 facilitates a communication session regarding the data, between the application session 308 and the expert session 708. For example, the expert session 700, responsive to detecting presentation of the data via the application session 308, can request feedback regarding the data (e.g., user input via the application session 308 for feedback regarding the data), and provide the feedback to the client device 704 to present via the expert session 708. The expert session 708 can receive expert feedback regarding at least one of the data or the feedback from the user to provide to the application session 308. In some implementations, the expert system 700 can facilitate any of various real-time or asynchronous messaging protocols between the application session 308 and expert session 708 regarding the data, such as any of text, speech, audio, image, and/or video communications or combinations thereof. This can allow the expert system 700 to provide a platform for a user receiving the data (e.g., customer or field technician) to receive expert feedback from a user of the client device 704 (e.g., expert technician). In some implementations, the expert system 700 stores a record of one or more messages or other communications between the sessions 308, 708 in the data repository 204 to facilitate further configuration of the machine learning models 268 based on the interactions between the users of the sessions 308, 708.

### Building Data Platforms and Digital Twin Architectures

Referring further to FIGS. 1-7, various systems and methods described herein can be executed by and/or communicate with building data platforms, including data platforms of building management systems. For example, the data repository 204 can include or be coupled with one or more building data platforms, such as to ingest data from building data platforms and/or digital twins. The client device 304 can communicate with the system 200 via the building data platform, and can feedback, reports, and other data to the building data platform. In some implementations, the data repository 204 maintains building data platform-specific databases, such as to facilitate the system 200 to configure the machine learning models 268 on a building data platform-specific basis (or on an entity-specific basis using data from one or more building data platforms maintained by the entity).

For example, in some implementations, various data discussed herein may be stored in, retrieved from, or processed in the context of building data platforms and/or digital twins; processed at (e.g., processed using models executed at) a cloud or other off-premises computing system/device or group of systems/devices, an edge or other on-premises system/device or group of systems/devices, or a hybrid thereof in which some processing occurs off-premises and some occurs on-premises; and/or implemented using one or more gateways for communication and data management amongst various such systems/devices. In some such implementations, the building data platforms and/or digital twins may be provided within an infrastructure such as those described in U.S. patent application Ser. No. 17/134,661 filed Dec. 28, 2020, Ser. No. 18/080,360, filed Dec. 13, 2022, Ser. No. 17/537,046 filed Nov. 29, 2021, and Ser. No. 18/096,965, filed Jan. 13, 2023, and Indian patent application No. 202341008712, filed Feb. 10, 2023, the disclosures of which are incorporated herein by reference in their entireties.

### III. Generative AI-Based Systems and Methods for Equipment Servicing

As described above, systems and methods in accordance with the present disclosure can use machine learning models, including LLMs and other generative AI models, to ingest data regarding building management systems and equipment in various unstructured and structured formats, and generate completions and other outputs targeted to provide useful information to users. Various systems and methods described herein can use machine learning models to support applications for presenting data with high accuracy and relevance.

### Equipment Service Management Responsive to Fault Detection Using Machine Learning Models

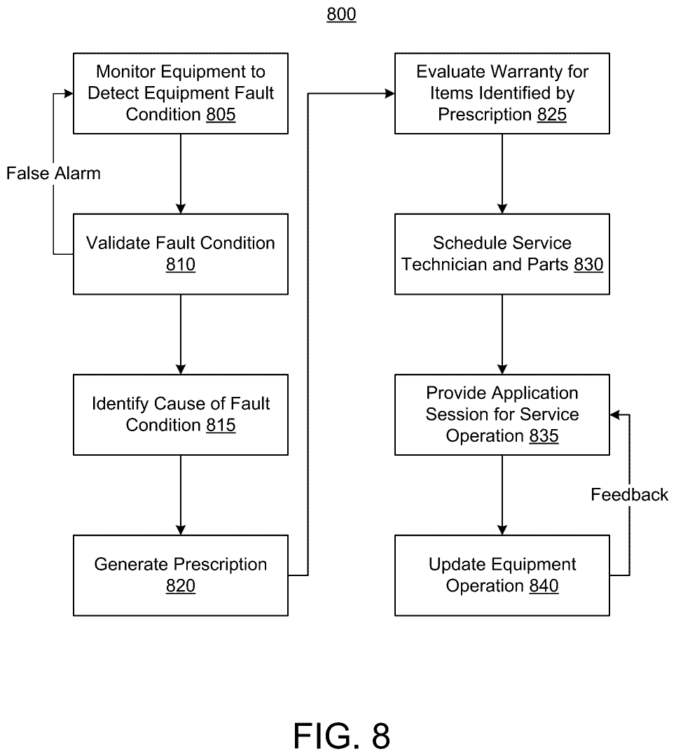

FIG. 8 depicts an example of a method 800. The method 800 can be performed using various devices and systems described herein, including but not limited to the systems 100, 200 or one or more components thereof. Various aspects of the method 800 can be implemented using one or more devices or systems that are communicatively coupled with one another, including in client-server, cloud-based, or other networked architectures.

At 805, a fault condition of an item of equipment can be detected. The fault condition can be detected responsive to manual and/or automated monitoring of various data sources regarding the item of equipment. In some implementations, the fault condition is detected responsive to an alarm notification from an alarm of the equipment or coupled with the equipment. For example, sensor data of the equipment or from a sensor directed to the equipment can be monitored by the alarm, and evaluated according to one or more alarm conditions (e.g., threshold values) to trigger the alarm notification. The fault condition can be detected responsive to user input indicative of the fault condition, or images or other data received indicative of the fault condition.

At 810, the fault condition can be validated. For example, the fault condition can be validated to determine whether the alarm notification corresponds to a false alarm. In some implementations, the fault condition can be validated by verifying the data used to detect the fault condition at a second point in time (e.g., subsequent to a first point in time at which the fault condition was initially detected), such as by evaluating the one or more alarm conditions using data regarding the equipment at the second point in time; this may include using the same or different data than the data used to initially detect the fault condition to validate the fault condition. The fault condition can be validated by providing the alarm notification to a device of a user, and requesting a confirmation (or indication of false alarm) from the user via the device. Responsive to the fault condition being identified as a false alarm, the equipment can be continued to be monitored.

At 815, a cause of the fault condition can be identified, such as by performing a root cause analysis. In some implementations, the cause is detected using a function that includes one or more algorithms, tables, simulations, or machine learning models described herein. For example, at least one of an identifier of the equipment, the fault condition, user text or speech identifying the fault condition (e.g., notes from any of a variety of entities, such as a facility manager, on-site technician, etc.), or data regarding the equipment used to detect the fault condition can be applied as input to the function to allow the function to determine an indication of a cause of the fault condition. For example, the function can include a table mapping various such inputs to one or more causes of fault conditions. The function can include a machine learning model configured using various forms of data described herein. For example, the machine learning model can include one or more classifiers, language models, or combinations thereof that are trained using data that includes information indicative of fault conditions and associated causes of fault conditions.

At 820, a prescription is generated based on the cause of the fault condition. For example, one or more of the cause of the fault condition, the fault condition, and an identifier of the equipment can be provided to a language model to cause the language model to generate the prescription. The prescription can have a natural language format. The prescription can indicate one or more actions for a service technician to perform to verify, service, and/or repair the fault condition, such as instructions for tools and/or parts to use for the item of equipment. The language model can include any of various models described herein that are configured, using training data representative of prescriptions. The prescription can be generated for presentation using various output modalities, such as text, speech, audio, image, and/or video, including in real-time, conversational, or asynchronous formats.

In some implementations, generating the prescription includes conditioning or guiding the language model to generate the prescription based on a class of at least one of the service technician or the site at which the item of equipment is present. For example, the language model can have its configuration (e.g., training, etc.) modified according to labels of identifiers or classes of technicians, sites, types of equipment, or other characteristics relating to the item of equipment and/or the service technician, which can provide the prescription to be generated in a manner that is more accurate and/or relevant to the service to be performed.

At 825, a warranty is evaluated based on one or more items (e.g., the equipment, parts or tools for servicing the equipment) identified by the prescription. For example, the warranty can be retrieved from various sources, such as a contract database associated with the entity that maintains the site, according to an identifier of the type of equipment, from the service request, or various combinations thereof. The prescription (or the service request) can be parsed to identify one or more items, such as items of equipment, identified by the prescription. For example, the item of equipment for which the service request is generated can be identified from the prescription, and compared with the warranty (e.g., using natural language processing algorithms, etc.) to identify one or more warranty conditions assigned to the item of equipment. The warranty conditions can indicate, for example, timing criteria for authorizing and/or payment for servicing the item of equipment by a vendor or supplier of the item of equipment. Responsive to the warranty conditions being satisfied (e.g., a termination of the warranty not being met), various actions can be performed to trigger servicing of the item of equipment. In some implementations, one or more warranty conditions are evaluated prior to, during, and or subsequent to generation of the prescription, such as to allow the prescription to be generated to incorporate one or more outputs of the evaluation of the warranty (or avoid computational resources for generating the prescription responsive to the warranty conditions not being satisfied).

At 830, scheduling of deployment of at least one of a service technician or one or more parts identified by the prescription can be performed. In some implementations, the prescription can identify the service technician, such as to select the service technician from a plurality of candidate service technicians according to an expertise that the service technician is labeled with and which corresponds to the item of equipment. Scheduling deployment of the one or more parts can including identifying a provider of the one or more parts and assigning the one or more parts to a vehicle (e.g., trucks) for delivering the one or more parts to the site of the item of equipment. By using the language model to generate the prescription—which identifies the one or more parts—the one or more parts that are delivered to the site can be more accurately identified, which can reduce resource usage and/or wasted space or weight on the vehicle. In some implementations, scheduling deployment includes generating a service ticket indicative of the service to be performed, such as to identify the service technician, the parts, and/or the item of equipment.

Depending on the determined prescription, the scheduling can include automated servicing of the item of equipment, such as to provide commands to adjust parameters of the item of equipment to a controller of the item of equipment. The scheduling can include providing instructions for performing remote service, such as to provide instructions to a service technician to use on-site tools and/or parts, or manual adjustment of the item of equipment, to service the item of equipment (e.g., to avoid a truck deployment or truck roll to the site).

At 835, an application session for a service operation corresponding to the service request (and the prescription) can be provided. In some implementations, the application session is provided via a device of the service technician. For example, the device can provide one or more credentials to access the application session (e.g., credentials that uniquely identify the service technician). The application session can present information to the service technician in any of various conversational, messaging, graphical, real-time, and/or asynchronous formats. The application session can receive one or more prompts from the device (e.g., from a user input device of the device), and provide the one or more prompts to the language model to cause the language model to provide corresponding completions responsive to the one or more prompts. For example, the device can receive text or image data (among other formats) as inputs provided by actions of the user (e.g., via an input interface of the device; by the user controlling a camera of the device), and provide the inputs as prompts to the language model. The application session can present the completions via the device to facilitate guiding the service technician through the actions to perform to service the item of equipment. In some implementations, the application session automatically (e.g., responsive to detecting a condition for escalating the guidance to a human expert) or manually (e.g., responsive to user input requesting guidance from a human expert) can establish a communication session between the device and a device of a human expert to provide further guidance to the service technician; the language model can provide various information such as the service request, prescription, and/or communications between the user and the language model via the application session to the device of the human expert, and can label various portions of the communications as potential causes of the escalation. The application session can be implemented as a virtual assistant, such as to provide information such as instruction manuals or technical reports regarding the item of equipment, responsive to requests from the service technician inputted at the device of the service technician.

At 840, operation of the item of equipment can be updated responsive to one or more actions performed by the service technician. For example, various parameters of operation of the item of equipment, such as setpoints, can be updated according to the one or more actions.

In some implementations, information from the service request, prescription, and application session processes can be used to perform analytics regarding entities that maintain sites and items of equipment (e.g., to evaluate customer churn). For example, information including unstructured data (e.g., service reports) regarding items of equipment and entity engagement or disengagement (e.g., deals) can be correlated to identify patterns regarding ways that service can be performed to maintain or increase the likelihood of increasing performance of one or more items of equipment of the entity, completion of deals or of maintaining engagement with the entity.

### Operator Interfaces Blending Objectives Using Machine Learning Models

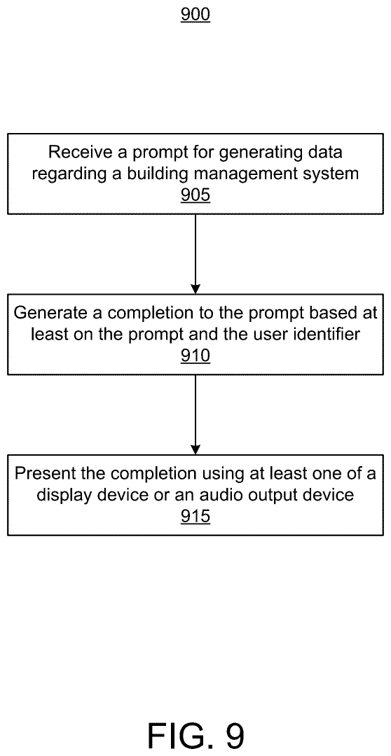

FIG. 9 depicts an example of a method 900. The method 900 can be performed using various devices and systems described herein, including but not limited to the systems 100, 200 or one or more components thereof. Various aspects of the method 900 can be implemented using one or more devices or systems that are communicatively coupled with one another, including in client-server, cloud-based, or other networked architectures.

The method 900 can correspond to a service-oriented artificial intelligence (AI) operator user interface. In some implementations, one or more processing circuits executing method 900 can use a generative AI model (e.g., first model 104, the second model 116), integrated with a generative AI (GAI) chatbot as part of a service model and/or architecture (e.g., for one or more components of system 100 and/or system 200). In some implementations, method 900 can include automatically generating a user experience based on each individual's needs and preferences. For example, through machine learning algorithms, the processing circuits can learn from user interactions and feedback to continuously evolve and refine the user interface (e.g., of a service operator or building manager).

In some implementations, the processing circuits can determine operational goals of the facility or building manager. Based on these goals, the processing circuits can propose operating parameters and update Key Performance Indicators (KPIs) in real-time. For example, skeleton code can be created. In some implementations, the method 900 can include on-the-fly UI generation. For example, a dedicated UI, or a portion of it, can be updated based on what the user prioritizes as identified by the GAI. While typical goal management systems can require static and/or predetermined inputs, parameters, and/or KPIs, which can require many calculations to evaluate and/or UI navigation steps through multiple UIs in order to reach a final output, systems and methods that implement various operations described with respect to method 900 can utilize the AI features described herein, including, for example, natural language processing of user inputs, dynamic UI generation, and/or dynamic KPI updating, to allow for the system to be more responsive to user inputs, reduce UI navigation steps, and/or provide more accurate KPIs (which in turn can reduce errors in KPI generation and/or reduce the number of user inputs required to determine KPIs).

In various implementations, the processing circuits can employ reinforcement learning, which allows the GAI model to adapt and update from one or more user interactions. In some implementations, the processing circuits can generate and employ customized natural language interaction based on account information, such as the user's role (e.g., building operator, service operator). Furthermore, method 900 can generally synthesize various reports such as a Fault Detection and Diagnosis (FDD) report, health report, service report, and other report. This can provide a consistent look and feel (e.g., consistent with respect to a user template and/or previous reports for a given user or user role) and/or formalize the reporting process.

Still referring to method 900 generally, which can begin by receiving a prompt identifying a piece of equipment that needs service, the processing circuits executing a generative AI model can generate a completion representing the service action to perform on the item of equipment. The model can use training data that includes a variety of unstructured data elements corresponding to equipment items. The completion can then be presented using a display device or an audio output device, providing a service action to meet the user's needs.

At block 905, a prompt for generating data regarding a building management system (BMS), from a device associated with a user identifier, can be received. In various implementations, the processing circuits can receive the input from a device linked with a particular user identifier or building identifier. For example, the prompt can be a request or query related to generating data concerning the operation, management, or status of a BMS.

In various implementations, the prompt can be received via any of various user interfaces such as a desktop application, mobile app, or a voice-activated assistant, and can be provided through the user's device to the processing circuits. The user identifier can include a unique identifier that links the device to a specific individual such as a building manager, a maintenance technician, or another professional associated with the building management system. The user identifier can allow for a personalization of responses based on one or more attributes of the user (e.g., as stored in a database and/or inferred by processing of one or more stored attributes by a language model), such as the user's role, permissions, and/or preferences. In some implementations, a building identifier can be provided. The building identifier can uniquely represent a particular building or facility within the BMS. For example, a building identifier might be used to distinguish between two buildings within the same campus, or to differentiate between several facilities managed by the same organization but located in different geographical locations.

In various implementations, in response to receiving the prompt for generating data the processing circuits can access or identify operational data of the one or more sensors attached to the building management system. The operational data can be from a plurality of points in time. For example, the operational data can correspond to measured parameters including at least one of, but not limited to, temperature measurements, indoor air quality measurements, pressure measurements, vibration measurements, decibel measurements, flow rate measurements, energy consumption measurements, electrical current measurements. The various measured parameters can be used to generate performance and condition data of the building management system. In some implementations, accessing may be facilitated by accessing a controller of the item of equipment or the item of equipment itself using network communications (e.g., exchanging data packets). For example, the processing circuits can automatically retrieve historical and real-time data from the sensors through the building management system's control interface. In some implementations, identifying may be facilitated by using network communications to identify and retrieve the relevant data from the item of equipment. For example, the processing circuits can establish a connection to the building management system's controller to gather operational data.

At block 910, a completion to the prompt can be generated. The completed can be generated based at least on the prompt and the user identifier. The completion can indicate one or more actions corresponding to a performance target for the BMS. The completion can be generated using at least one generative artificial intelligence (AI) model and based on the prompt. In various implementations, the processing circuits can execute at least one generative AI model to output a completion to the prompt. This completion can represent an actionable response that informs the next steps that need to be taken with regards to the BMS. In some implementations, the generation of the completion is based on initial prompt and the user identifier. This can provide an output that is relevant and aligns with the user's authority and responsibilities with respect to the BMS.

The processing circuits can indicate one or more actions that can be taken to achieve a given performance target for the BMS. For example, these actions can include, for example and without limitation, suggesting adjustments to the HVAC settings or recommending preventative maintenance for certain pieces of equipment. For example, based on the example data used to configure the at least one generative AI model, the processing circuits can cause the at least one generative AI model to generate the one or more actions, based on the prompt, in a manner analogous to actions represented in the example data as being associated with updates to performance targets for BMSs.

In various implementations, the processing circuits can transform the prompt, which may be in the form of natural language text, into a format that can be processed by the generative AI model. The generative AI model, executed by the processing circuits, can then analyze the input, alongside the context provided by the user identifier, and generate a response. This output, which consists of suggested actions to be taken, can then be transformed (e.g., by the processing circuits) back into a format that can be understood by the user.

In various implementations, the processing circuits can identify the performance target by processing the prompt using at least one generative AI model. Performance targets can define goals assigned to or determined by the building management system. These targets can include operating parameters of one or more items of equipment associated with the building management system (BMS), or the Key Performance Index (KPI) of the equipment. The operating parameters can be specific characteristics or variables that define how a piece of equipment operates. These parameters could include, but are not limited to, energy consumption, temperature settings, airflow rates for an HVAC system, or operating times for various equipment. In processing the prompt, the processing circuits parse the data and use the AI model to identify these parameters as they relate to the identified equipment. In some implementations, the processing circuits then compare these identified operating parameters with the standard or desired settings. For example, any discrepancies between the current and desired states indicate areas where service actions may be required. In this example, the generative AI model would use this information to generate a service action that can bring the equipment's performance to the desired parameters.

Additionally, KPIs can be quantifiable measures such as, but not limited to, energy efficiency, equipment uptime, maintenance costs, indoor air quality (IAQ), comfort level indicators like temperature and humidity consistency, energy efficiency ratio (EER), seasonable energy efficiency ratio (SEER), coefficient of performance (COP), heating seasonal performance factor (HSPF), HVAC system runtime, equipment maintenance and lifecycle costs, occupant comfort, duck leakage rate, and system load. Accordingly, the processing circuits can use the generative AI model to identify the KPIs mentioned or implied in the prompt. That is, the generative AI model can be trained to understand the relationship between various equipment issues and their impact on these KPIs. For example, a prompt might indicate that an HVAC system is using more energy than expected. The processing circuits would identify the high energy use as the immediate issue, but the AI model could also infer that this issue impacts the KPI of energy efficiency. Therefore, the proposed service action would aim not only to reduce energy consumption but also to improve overall energy efficiency as per the KPI target.

A KPI can be a measurable value that measures how effective a piece of equipment or a system is at achieving business objectives. A KPI can be associated with a variety of performance metrics and can be industry-specific or tailored to a particular organization's needs. Thus, KPIs can serve as quantifiable benchmarks against which the performance of the system or individual pieces of equipment can be measured and evaluated. In various arrangements, KPIs can be selected by the processing circuits based on their relevance to the specific goals of the system or equipment. For example, energy efficiency might be a KPI for an HVAC system in a building aiming to minimize its environmental impact, whereas for a data center, the uptime of the cooling system might be a more critical KPI.

In various implementations, the KPIs can be quantified and tracked over time. For example, energy efficiency can be measured in terms of energy use per square foot, and equipment uptime can be measured in terms of the percentage of time the equipment is operational. Additionally, as used herein, building parameters refer to the operational variables of the equipment (e.g., temperature settings for an HVAC system or operating times for lighting systems). These parameters can be adjusted to alter the performance of the system. Building measurements can to quantifiable metrics that provide information about the system's performance or the building's environment. For example, IAQ is a building measurement that indicates the healthiness of the building's air, measured by factors such as CO2 levels, particulate matter, and volatile organic compounds.

Still referring to block 910, the training data can include data from at least one other item of equipment or a building that has been previously modified to achieve a related Key Performance Indicator (KPI). In particular, a related KPI is a measurable metric that is associated with either a parameter of the other item of equipment or building or the value of the parameter. That is, related KPIs can be used by the processing circuit to determine potential influences on the performance and status of the equipment, including the equipment's operating settings, the conditions within the building, or other external factors that might impact equipment performance.

The generative AI model can include at least one neural network that includes at least one transformer. As described above, transformer models, a specific type of neural network architecture, can be particularly useful in understanding and generating service actions. Moreover, transformers can process inputs in parallel (rather than sequentially) and can employ attention mechanisms, allowing the model to focus on different parts of the input when generating an output.

In some implementations, the processing circuits can generate skeleton code to execute one or more actions. This skeleton code, generated by the one or more processors, can include one or more code sections, each corresponding to one or more actions indicated by the generated service action. Skeleton can include a template of code, such as a bare-bones version of a codebase that provides a structure while leaving the details to be filled in based on specific requirements. That is, skeleton code refers to a stripped-down version of a codebase that sets up the structure, while leaving the specifics to be customized according to individual requirements. For example, the skeleton code can serve as a framework for executing the proposed service actions. Each code section can correspond to a different service action, providing a blueprint that can be customized and expanded to handle the specifics of that action (i.e., providing an implementation plan). In some implementations, the skeleton code includes pseudo-code. In some implementations, the skeleton code includes one or more function calls in a target order and/or identifiers of data structures, which a user can complete using variables or parameters specific to the one or more actions. In some implementations, the skeleton code includes at least a portion of code of a program, and can have syntax corresponding to commands for the components to be operated according to the program, which can reduce or avoid errors in generating the code. Various machine learning models described herein, having been configured using examples of code and/or skeleton code representative of the one or more actions, can be provided to generate the skeleton code.

In various implementations, the processing circuits can receive input to update the skeleton code. This input could come from the user, from other parts of the BMS, or from additional data sources that the processing circuits have access to. In some implementations, the input can include a modification(s) or instruction(s) to update at least one operating parameter of the building management system. That is, the operating parameters can be adjusted to optimize performance based on the input. For example, the input could provide additional details or specifications related to the service action, or it could suggest alternative ways of implementing the action. In another example, the modification to update the operating parameters can involve altering specific settings to improve efficiency. In yet another example, the instruction to update the operating parameters can direct changes to meet new performance targets. Based on the input, the processing circuits can then update the skeleton code. That is, updating can include incorporating the at least one modification or implementing the at least one instruction. For example, incorporating the at least one modification can include adjusting the parameters specified in the code to reflect new requirements. In another example, implementing the at least one instruction can include rewriting sections of the code to align with updated operational goals. It should be understood that the one or more code sections of the skeleton code could correspond to a wide variety of actions, to handle diverse equipment types and service scenarios. These actions could include adjusting energy usage, modifying temperature control settings, altering lighting conditions, reconfiguring space utilization, updating air quality indicators, revising security protocols, updating maintenance schedules, or optimizing waste management. That is, each of these actions can require unique code implementations. For example, adjusting energy usage could include writing code to change the settings on a power control unit, while modifying a temperature control setting might involve altering the thermostat settings in an HVAC system.

In some implementations, the processing circuits can activate a co-pilot model of the generative AI model by initiating a session to assist in achieving performance targets for the building management system based on the plurality of unstructured data elements and the operational data of the building management system. Activating can include initiating a session with the co-pilot model through an interface, such as a software application or web-based platform. For example, this could involve a user logging into a management portal where the co-pilot model is accessible and starting a new session specific to the performance targets in question. In some implementations, initiating the co-pilot based on the plurality of unstructured data elements and the operational data can include pre-loading the session with relevant data from the building's history, recent performance metrics, and any recent diagnostic data collected. The co-pilot model of the generative AI model may be trained and deployed to provide real-time assistance and recommendations. For example, the co-pilot can analyze live data streams from sensors attached to the building systems and provide immediate feedback on performance issues. In this example, the co-pilot model can be customized to interact with the user by suggesting adjustments, providing step-by-step optimization instructions, or simulating potential outcomes based on different actions. In some implementations, the session can be facilitated through a display or viewport of a client device. For example, the user could use a tablet or augmented reality headset to view the co-pilot's recommendations overlaid on the building management system's interface. In the session, the processing circuits can receive the prompts and provide feedback that guides the user through the optimization process. Additionally, initiating a session may be for routine performance monitoring, emergency response, system upgrades, or any other specific action as dictated by the operational requirements of the building management system.

Typical conversational AI systems are often implemented for broad, topic-agnostic interactions and lack domain-specific specialization. In contrast, the co-pilot model and implementations described herein integrate specialized training data from unstructured elements specific to various domains. These elements can include service reports, maintenance records, manufacturer instructions, images of equipment, audio recordings of operating sounds, expert technician records, and media containing identification tags or labels. This diverse and tailored data provides the source for the co-pilot model to generate precise and actionable instructions, recommendations, and strategies. The co-pilot model can interpret real-time data streams, providing immediate feedback based on live operational conditions. In some implementations, the processing circuits executing the co-pilot model can interface with users through various devices, such as augmented reality headsets or service portals, facilitating context-aware assistance. The design of the co-pilot model relates to integrating operational data and specific task-related information, unlike typical conversational AI systems that do not provide domain-specific, actionable insights or real-time feedback based on such training data.

In some implementations, the processing circuits can execute a generative AI model to assist with actions related to performance targets of the building management system. The generative AI model, also referred to as a co-pilot model or co-pilot, can utilize unstructured data such as service manuals, historical performance data, other insights, and real-time operational data. When a user needs to achieve specific performance targets, the co-pilot model can provide immediate, context-specific assistance. For example, the user can input a question or provide real-time data from the building management system, and the co-pilot model can extract relevant information, such as current performance metrics and associated historical data, from the provided data. The co-pilot model can facilitate the interaction with a knowledge base through a natural language interface, improving the process of achieving performance targets. The processing circuits can further enhance these capabilities by integrating multimodal data sources, using video and audio inputs to access building information and generate accurate recommendations.

Furthermore, the processing circuits can receive real-time operational data from the building management system. The real-time operational data can include, but is not limited to, at least one of energy usage data, temperature reading, lighting condition, space utilization metric, air quality indicator, security status, maintenance schedule, or waste management metric. For example, the temperature reading can be a current measurement from the HVAC system and could be received from a temperature sensor within the building. In another example, the lighting condition can be the current brightness level and could be received from smart lighting sensors. In yet another example, the space utilization metric can be the number of occupants in a room and could be received from occupancy sensors. In yet another example, the air quality indicator can be the level of CO2 and could be received from an air quality monitoring device. In yet another example, the security status can be the current status of access points and could be received from security system sensors. In yet another example, the maintenance schedule can be the planned maintenance activities and could be received from the maintenance management system. In yet another example, the waste management metric can be the current fill level of waste containers and could be received from smart waste management sensors. In some implementations, the processing circuits can generate updates to the completion based on the real-time operational data. That is, the updates to the completion can include at least one modification to the one or more actions to align with the performance target. For example, an update to the completion may be an adjustment to HVAC settings to improve energy efficiency based on current temperature readings. In another example, the update to the completion may be scheduling an immediate maintenance action due to an unexpected increase in equipment temperature. In some implementations, generating the updates can include analyzing the real-time data to detect anomalies and adjust the recommended actions accordingly.

In some implementations, the processing circuits can activate a co-pilot model of the generative AI to facilitate executing the one or more actions related to the performance target. That is, the co-pilot model can be a generative AI model specially trained to provide real-time recommendations and adjustments based on dynamic data inputs. In some implementations, activating can include initiating a session with the co-pilot model through a user interface. For example, the session may be initiated by a building manager accessing the system through a web-based dashboard. The user interface can receive the real-time operational data and a plurality of prompts. That is, the real-time operational data may be continuous streams from building sensors, and the prompts can be specific queries or commands from the user. For example, a prompt may ask for the best way to reduce energy consumption in the next hour. In some implementations, activating can also include modeling, using the co-pilot model, the real-time operational data and the plurality of prompts to generate one or more actionable recommendations corresponding to the performance target. That is, modeling the real-time operational data and the plurality of prompts can include integrating the data to predict outcomes and suggest optimal actions. For example, adjusting the HVAC settings to balance energy use and occupant comfort. The actionable recommendations may be specific instructions or adjustments. For example, turning off unnecessary lighting in unoccupied areas. In some implementations, activating can also include presenting the one or more actionable recommendations via the user interface. For example, the actionable recommendations can be displayed on the dashboard in a prioritized list. That is, presenting can include visualizing the recommendations with clear instructions and expected outcomes. In some implementations, activating can also include updating the one or more actionable recommendations based on new real-time operational data or a new prompt. For example, as new real-time operational data is received or accessed, the co-pilot model can adjust the recommendations to reflect the latest conditions. In another example, as new prompts are received or accessed, the co-pilot model can generate additional recommendations or modify existing ones. Thus, activating the co-pilot model can include continuously integrating new data and user inputs to maintain optimal performance and/or satisfy one or more standards (e.g., ASHRAE standard(s)).

In some implementations, generating the completion representing the service action can be based on receiving the prompt and the operational data (e.g., real-time, near real-time, or periodically) being provided as input into the at least one generative AI model. That is, the prompt and operational data can be processed together to contextualize the actions corresponding to the performance target. For example, the prompt might describe a desired report or view of data of the building management system, and the operational data could provide real-time performance metrics or current operational standards to further refine the report or data. In another example, the prompt might request a maintenance check, and the operational data could indicate specific building equipment of the building management system where performance is suboptimal, guiding the focus of the maintenance. In some implementations, the co-pilot model that was activated can take the prompt from the user and provide and/or generate operational data in a format to provide as input to the AI model. For example, the co-pilot model can convert a verbal description of desired data into a structured data format that the AI model can process. In another example, the co-pilot model can integrate sensor data readings with the user's input to enhance the accuracy and relevance of the generated actions.

That is, unlike in typical conversational AI systems where the interaction is generally limited to processing and responding to user inputs in natural language, the co-pilot model can supplement the input data with additional data sources such as real-time operational data, historical maintenance records, sensor readings, and manufacturer guidelines. This integration results in the co-pilot model processing and analyzing a broad set of data concurrently, providing accurate and context-specific actions related to a performance target. For example, while a typical conversational AI system may generate a response based on the user's description of an issue, the co-pilot model can incorporate historical service data, real-time sensor data such as temperature or vibration levels, and manufacturer instructions to determine accurate and calibrated data points. This multi-source input can facilitate the generation of improved output and actionable recommendations. Additionally, the co-pilot model can pre-process and format the diverse data sources into structured formats that the AI model can efficiently utilize, improving the relevance and effectiveness of the generated actions for the building management system.

At block 915, the completion, which indicates one or more actions to reach a performance target for the building management system, can be presented using at least one of a display device or an audio output device. The completion, generated using at least one generative AI model, can be based on both the prompt and the user identifier. Depending on the recipient, the presentation mode of the completion can vary. For example, for a technician servicing the equipment, the service action could be displayed as detailed instructions on a handheld device, or through an augmented reality display on a smart helmet, or delivered as voice-guided instruction via earphones. In another example, if the recipient is an automated control system within the building management system, the completion could be conveyed as a set of machine-readable and executable instructions.

In some implementations, the processing circuits personalize the user interface (UI) that is presented on the display with the completion. This personalization is based on the user identifier (or building identifier) and can take into account various factors such as user preferences, interests, or previous interactions associated with using the generative AI model. For example, a user who frequently interacts with the HVAC controls might see more HVAC-related options or information on their UI. In another example, if a user prefers a graphical presentation of data, the UI might feature more charts and visualizations.

Referring to personalization and customization of the UI in more detail, the processing circuits can use individual preferences, individual interactions, and characteristics associated with the user's role or the building identifier. The processing circuits can adjust the UI to display information pertinent to a user's role, such as specific tasks or responsibilities. For example, a building manager might see a UI focusing on overarching building performance metrics and upcoming maintenance schedules, whereas a technician may view a UI geared towards detailed equipment diagnostics and service guidelines. In the case of a building identifier, the UI may adapt based on the building's specific parameters, such as type of the building (commercial, residential, industrial), the equipment installed, the building's age or its geographic location.

In some implementations, the actions generated by the processing circuits can include customized natural language based on account information associated with the user identifier. The customized natural language can be tailored according to several factors, including the choice of vocabulary, level of technicality, depth of detail, or preferred communication style. For example, a user who works as a maintenance technician might receive instructions with specific, technical language, whereas a facility manager might receive broader, more strategic information. In another example, a trainee technician might receive a service action instruction written in simple language and with a greater depth of detail, including step-by-step guidance, definitions of technical terms, and safety precautions. On the other hand, an experienced engineer could receive the same instructions written in advanced technical language, with the assumption of their existing knowledge base, and offering deeper details such as the theoretical background of the issue, potential root causes, and troubleshooting steps to address complex or rare complications. In yet another example, a user who has indicated a preference for concise, bullet-point information might receive service action instructions in a list format with succinct, direct language. Conversely, a user who prefers a more narrative, explanatory style may receive the same instructions formatted as a continuous paragraph, with each action point elaborated upon and the reasoning behind it explained. That is, the generative AI model can be configured (e.g., trained and deployed) using training data including the account information. In some implementations, configuring the AI model using the account information can include adjusting the training data to incorporate user preferences and roles. For example, the training data might be supplemented with examples of communications tailored to different roles, such as technical reports for engineers or high-level summaries for managers.

In some implementations, the completion presented to the user includes the synthesis of one or more reports. The presentation of this completion can feature a design customized to the user identifier or the BMS. For example, the user identifier may be associated with a specific role or department, or the BMS may have particular formatting standards. In this example, the user identifier or the BMS can be used to customize the presentation format and detail level to match the user's role or the system's requirements. In particular, the reports can be formatted or organized in a way that is familiar and intuitive to the user or that aligns with the overall branding or visual style of the BMS. For example, a maintenance report could be presented as a checklist for a technician or as a pie chart showing the proportion of different types of maintenance tasks for a facility manager. In some implementations, the synthetization can include aggregating data and content of the one or more reports from a plurality of data sources. That is, aggregation can include combining historical maintenance records, real-time sensor data, and manufacturer guidelines into a unified report. For example, integrating the various data sources can provide an overview of the current system status and historical performance trends. In some implementations, the processing circuits can generate insights corresponding with one of a plurality of performance targets or operational goals of the building management system. For example, the insights of performance targets can be related to energy efficiency improvements over time. In another example, the insights of operational goals can be focused on enhancing occupant comfort by optimizing HVAC settings. That is, generating insights can include analyzing the aggregated data to identify trends, anomalies, and actionable recommendations to meet specific performance targets or operational goals.

In some implementations, the generative AI model implements reinforcement learning. This can include updating the model based on feedback received regarding the effectiveness of the generated completions indicating the actions. This could include explicit feedback from the users or implicit feedback based on the processing circuits or BMS's observations of user behavior or the outcomes of the implemented actions. For example, if a suggested action leads to significant energy savings, the processing circuits implementing the model might prioritize similar actions in the future. Conversely, if a proposed action does not resolve a reported issue, the processing circuits implementing the model might adjust its approach for similar situations.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

In various implementations, the steps and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular building or portion of a building. In some implementations, the operations may be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed is:

1. A method, comprising:
receiving, by one or more processors, from a device associated with a user identifier, a prompt for generating data regarding a building management system;
generating, by the one or more processors, using at least one generative artificial intelligence (AI) model, a completion to the prompt based at least on the prompt and the user identifier, the completion indicating one or more actions corresponding to a performance target for the building management system; and
presenting, by the one or more processors, the completion using at least one of a display device or an audio output device.

2. The method of claim 1, further comprising:
identifying, by the one or more processors, the performance target by processing the prompt using the at least one generative AI model, wherein the performance target comprises at least one of an operating parameter of one or more items of equipment associated with the building management system or a key performance index (KPI) of the one or more items of equipment.

3. The method of claim 1, wherein the at least one generative AI model is configured using training data comprising data of at least one other item of equipment or building previously modified to achieve a related KPI, wherein the related KPI is a measurable metric associated with at least one of (i) an operating parameter of the at least one other item of equipment or building or (ii) a value of the operating parameter, and wherein the generative AI model comprises at least one neural network comprising at least one transformer.

4. The method of claim 1, further comprising:
generating, by the one or more processors, skeleton code to execute the one or more actions, wherein the skeleton code comprises one or more code sections corresponding to the one or more actions, and wherein the one or more code sections comprises the skeleton code corresponding to at least one of adjusting an energy usage, modifying a temperature control setting, modifying a lighting condition, reconfiguring a space utilization, updating an air quality indicator, updating a security protocol, updating a maintenance schedule, or optimizing a waste management;
receiving, by the one or more processors, input to update the skeleton code, wherein the input comprises at least one modification or at least one instruction to update at least one operating parameter of the building management system; and
updating, by the one or more processors, the skeleton code based on the input, wherein updating the skeleton code comprises incorporating the at least one modification or implementing the at least one instruction into the skeleton code.

5. The method of claim 1, further comprising:
receiving, by the one or more processors, real-time operational data from the building management system, wherein the real-time operational data comprises at least one of energy usage data, temperature reading, lighting condition, space utilization metric, air quality indicator, security status, maintenance schedule, or waste management metric; and
generating, by the one or more processors, updates to the completion based on the real-time operational data, wherein the updates to the completion comprise at least one modification to the one or more actions to align with the performance target.

6. The method of claim 5, further comprising:
activating, by the one or more processors, a co-pilot model of the generative AI to facilitate executing the one or more actions related to the performance target, wherein activating the co-pilot model comprises:
initiating a session with the co-pilot model through a user interface, wherein the user interface receives the real-time operational data and a plurality of prompts;
modeling using the co-pilot model, the real-time operational data and the plurality of prompts to generate one or more actionable recommendations corresponding to the performance target;
presenting the one or more actionable recommendations via the user interface; and
updating the one or more actionable recommendations based on new real-time operational data or a new prompt.

7. The method of claim 6, wherein the user interface is presented on the display device comprising the completion, and wherein the user interface is personalized to the user identifier based on a user preference, a user interest, or a previous interaction associated with using the at least one generative AI model.

8. The method of claim 1, wherein the one or more actions comprise customized natural language based on account information associated with the user identifier, wherein the customized natural language is customized, using the account information, according to at least one of a choice of vocabulary, a level of technicality, a depth of detail, or a preferred communication style, and wherein the generative AI model is configured using training data comprising the account information.

9. The method of claim 1, wherein the completion comprises a synthetization of one or more reports, wherein the presentation of the completion comprises a design customized to the user identifier or the building management system, and wherein the synthetization comprises:
aggregating data and content of the one or more reports from a plurality of data sources; and
generating insights corresponding with one of a plurality of performance targets or operational goals of the building management system.

10. The method of claim 1, wherein the at least one generative AI model implements reinforcement learning, wherein the reinforcement learning comprises updating the at least one generative AI model based on receiving feedback on an effectiveness of generated completions indicating the one or more actions.

11. A system, comprising:
processing circuits comprising memory and at least one processor configured to:
receive from a device associated with a user identifier, a prompt for generating data regarding a building management system;
generate using at least one generative artificial intelligence (AI) model, a completion to the prompt based at least on the prompt and the user identifier, the completion indicating one or more actions corresponding to a performance target for the building management system; and
present the completion using at least one of a display device or an audio output device.

12. The system of claim 11, the at least one processor is further configured to:
identify the performance target by processing the prompt using the at least one generative AI model, wherein the performance target comprises at least one of an operating parameter of one or more items of equipment associated with the building management system or a key performance index (KPI) of the one or more items of equipment.

13. The system of claim 11, wherein the at least one generative AI model is configured using training data comprising data of at least one other item of equipment or building previously modified to achieve a related KPI, wherein the related KPI is a measurable metric associated with at least one of (i) an operating parameter of the at least one other item of equipment or building or (ii) a value of the operating parameter, and wherein the generative AI model comprises at least one neural network comprising at least one transformer.

14. The system of claim 11, the at least one processor is further configured to:
generate skeleton code to execute the one or more actions, wherein the skeleton code comprises one or more code sections corresponding to the one or more actions, and wherein the one or more code sections comprises the skeleton code corresponding to at least one of adjusting an energy usage, modifying a temperature control setting, modifying a lighting condition, reconfiguring a space utilization, updating an air quality indicator, updating a security protocol, updating a maintenance schedule, or optimizing a waste management;
receive input to update the skeleton code, wherein the input comprises at least one modification or at least one instruction to update at least one operating parameter of the building management system; and
update the skeleton code based on the input, wherein updating the skeleton code comprises incorporating the at least one modification or implementing the at least one instruction into the skeleton code.

15. The system of claim 11, the at least one processor is further configured to:
receive real-time operational data from the building management system, wherein the real-time operational data comprises at least one of energy usage data, temperature reading, lighting condition, space utilization metric, air quality indicator, security status, maintenance schedule, or waste management metric; and
generate updates to the completion based on the real-time operational data, wherein the updates to the completion comprise at least one modification to the one or more actions to align with the performance target.

16. The system of claim 15, the at least one processor is further configured to:
activate a co-pilot model of the generative AI to facilitate executing the one or more actions related to the performance target, wherein activating the co-pilot model comprises:
initiating a session with the co-pilot model through a user interface, wherein the user interface receives the real-time operational data and a plurality of prompts;
modeling using the co-pilot model, the real-time operational data and the plurality of prompts to generate one or more actionable recommendations corresponding to the performance target;
presenting the one or more actionable recommendations via the user interface; and
updating the one or more actionable recommendations based on new real-time operational data or a new prompt.

17. The system of claim 16, wherein the user interface is presented on the display device comprising the completion, and wherein the user interface is personalized to the user identifier based on a user preference, a user interest, or a previous interaction associated with using the at least one generative AI model.

18. The system of claim 11, wherein the one or more actions comprise customized natural language based on account information associated with the user identifier, wherein the customized natural language is customized, using the account information, according to at least one of a choice of vocabulary, a level of technicality, a depth of detail, or a preferred communication style, and wherein the generative AI model is configured using training data comprising the account information.

19. The system of claim 11, wherein the at least one generative AI model implements reinforcement learning, wherein the reinforcement learning comprises updating the at least one generative AI model based on receiving feedback on an effectiveness of generated completions indicating the one or more actions.

20. A non-transitory computer readable medium (CRM) comprising one or more instructions stored thereon that, when executed by one or more processing circuits, cause the one or more processing circuits to perform operations comprising:
receiving from a device associated with a user identifier, a prompt for generating data regarding a building management system;
generating using at least one generative artificial intelligence (AI) model, a completion to the prompt based at least on the prompt and the user identifier, the completion indicating one or more actions corresponding to a performance target for the building management system; and
presenting the completion using at least one of a display device or an audio output device.
